(19) United States
(12) Patent Application Publication
(10) Pub. No.: US 2016/0091811 A1
(43) Pub. Date: Mar. 31, 2016

(54) ELECTROSTATIC CHARGE IMAGE DEVELOPING TONER, ELECTROSTATIC CHARGE IMAGE DEVELOPER, TONER CARTRIDGE, PROCESS CARTRIDGE, AND IMAGE FORMING APPARATUS

(71) Applicant: FUJI XEROX CO., LTD., Tokyo (JP)

(72) Inventors: Takatsugu DOI, Kanagawa (JP); Kosaku YOSHIMURA, Kanagawa (JP); Satoshi YOSHIDA, Kanagawa (JP); Soichiro KITAGAWA, Kanagawa (JP); Shinpei TAKAGI, Kanagawa (JP)

(21) Appl. No.: 14/595,759

(22) Filed: Jan. 13, 2015

(30) Foreign Application Priority Data
Sep. 25, 2014 (JP) 2014-195850

(51) Int. Cl. G03G 9/00

(52) U.S. Cl. CPC G03G 9/08755

(57) ABSTRACT

An electrostatic charge image developing toner includes a binder resin containing an amorphous polyester resin and a crystalline polyester resin, wherein a ratio of the crystalline polyester resin to a total of the amorphous polyester resin and the crystalline polyester resin is from 12% to 40% by weight, and the toner satisfies the following equations (1) and (2),

30° C.≦T1≦45° C. (1)

1.0×10⁸ Pa≦G′(X)≦5.0×10⁸ Pa (2)

wherein T1 represents a temperature at which a storage elastic modulus G′ is 1.0×10⁸ Pa, G′(X) represents a storage elastic modulus G′(B) at a temperature X′° C., and X′° C. represents a temperature at which a ratio of a storage elastic modulus G′(B) to a storage elastic modulus G′(A) has a maximum value.

### CROSS-REFERENCE TO RELATED APPLICATIONS

This application is based on and claims priority under 35 USC 119 from Japanese Patent Application No. 2014-195850 filed Sep. 25, 2014.

### BACKGROUND

1. Technical Field

The present invention relates to an electrostatic charge image developing toner, an electrostatic charge image developer, a toner cartridge, a process cartridge, and an image forming apparatus.

2. Related Art

In recent years, due to the development of equipment and a well-established communications network in an information-oriented society, an electrophotographic process has been widely used not only in a copy machine, but also in a network printer in offices, a personal computer printer, a printer of on-demand printing, and the like. Regardless of monochromatic or color printing, high image quality, high speed, high reliability, miniaturization, weight reduction, and energy saving properties for the electrophotographic process are being required with an increasingly higher degree.

Generally, in the electrophotographic process, a fixed image is formed through plural processes including electrically forming an electrostatic charge image through various units on a photoreceptor (an image holding member) using an optical conductive material, developing the electrostatic charge image by using a toner, transferring a toner image on the photoreceptor to a recording medium such as paper or the like directly or through an intermediate transfer member, and then fixing the transferred image on the recording medium.

### SUMMARY

According to an aspect of the invention, there is provided an electrostatic charge image developing toner including:

a binder resin containing an amorphous polyester resin and a crystalline polyester resin,

wherein a ratio of the crystalline polyester resin to a total of the amorphous polyester resin and the crystalline polyester resin is from 12% by weight to 40% by weight, and

the toner satisfies the following equations (1) and (2),

30° C.≦T1≦45° C. (1)

1.0×10⁸ Pa≦G′(X)≦5.0×10⁸ Pa (2)

wherein T1 represents a temperature at which a storage elastic modulus G′ is 1.0×10⁸ Pa; G′(X) represents a storage elastic modulus G′(B) at a temperature X′° C. (after thermal storage); and X′° C. represents a temperature at which a ratio of a storage elastic modulus G′(B) at the temperature X° C. after the toner is stored at the temperature X° C. for 2 hours (after thermal storage) to a storage elastic modulus G′(A) at a temperature X° C. before the toner is stored at the temperature X° C. (before thermal storage), [storage elastic modulus G′(B) (after thermal storage)/storage elastic modulus G′(A) (before thermal storage)], has a maximum value.

### BRIEF DESCRIPTION OF THE DRAWINGS

Exemplary embodiments of the present invention will be described in detail based on the following figures, wherein:

FIG. 1 is a schematic configuration view illustrating an example of an image forming apparatus according to an exemplary embodiment; and

FIG. 2 is a schematic configuration view illustrating an example of a process cartridge according to an exemplary embodiment.

### DETAILED DESCRIPTION

Hereinafter, exemplary embodiments of an electrostatic charge image developing toner, an electrostatic charge image developer, a toner cartridge, a process cartridge, an image forming apparatus, and an image forming method according to the invention will be described in detail.

Electrostatic Charge Image Developing Toner

An electrostatic charge image developing toner according to this exemplary embodiment (hereinafter, simply referred to as “toner” in some cases) includes a binder resin containing an amorphous polyester resin and a crystalline polyester resin, in which a ratio of the crystalline polyester resin to a total of the amorphous polyester resin and the crystalline polyester resin is from 12% by weight to 40% by weight, and the toner satisfies the following equations (1) and (2),

30° C.≦T1≦45° C. (1)

1.0×10⁸ Pa≦G′(X)≦5.0×10⁸ Pa (2)

wherein T1 represents a temperature at which a storage elastic modulus G′ is 1.0×10⁸ Pa; G′(X) represents a storage elastic modulus G′(B) at a temperature X′° C. (after thermal storage); and X′° C. represents a temperature at which a ratio of a storage elastic modulus G′(B) at the temperature X° C. after the toner is stored at the temperature X° C. for 2 hours (after thermal storage) to a storage elastic modulus G′(A) at a temperature X° C. before the toner is stored at the temperature X° C. (before thermal storage), [storage elastic modulus G′(B) (after thermal storage)/storage elastic modulus G′(A) (before thermal storage)], has a maximum value.

The toner according to the exemplary embodiment has both low temperature fixability and thermal storage properties. Although the reason is not clear, it may be assumed as follows.

When the toner according to the exemplary embodiment contains an amorphous polyester resin and a crystalline polyester resin as a binder resin, and the compatibility between the amorphous polyester resin and the crystalline polyester resin is adjusted, the amorphous polyester resin is easily plasticized. Therefore, the toner according to the exemplary embodiment has excellent low temperature fixability.

However, as described above, the amorphous polyester resin is highly plasticized in the toner having excellent low temperature fixability and the heat resistance of the toner is low. Thus, for example, when the toner is stored in a state of being heated in a developing device or the like, the toner is aggregated and both low temperature fixability and thermal storage properties are not easily achieved in some cases.

In the exemplary embodiment, it is found that when the compatibility between the amorphous polyester resin and the crystalline polyester resin is optimized, the storage elastic modulus G′ of the toner may be increased in a case where the toner is thermally stored under the condition of a softening temperature of the toner or lower while the plasticization of the amorphous polyester resin is maintained. Specifically, it is found that when a storage elastic modulus G′(B) (after thermal storage) at a temperature X′° C., at which a ratio of a storage elastic modulus G′(B) at the temperature X° C. after the toner is stored at the temperature X° C. for 2 hours (after thermal storage) to a storage elastic modulus G′(A) at the temperature X° C. before the toner is stored at the temperature X° C. (before thermal storage) [storage elastic modulus G′(B) (after thermal storage)/storage elastic modulus G′(A) (before thermal storage)] has the maximum value, is 1.0×10⁸ Pa or more, sufficient thermal storage properties may be obtained. In this manner, it is assumed that the toner according to the exemplary embodiment has both low temperature fixability and thermal storage properties.

In the exemplary embodiment, the ratio of the crystalline polyester resin to the total of the amorphous polyester resin and the crystalline polyester resin is set from 12% by weight to 40% by weight. When the ratio of the crystalline polyester resin to the total of the amorphous polyester resin and the crystalline polyester resin is less than 12% by weight, a temperature at which the storage elastic modulus G′ is 1.0×10⁸ Pa is increased, and thus the low temperature fixability is deteriorated in some cases. When the ratio of the crystalline polyester resin to the total of the amorphous polyester resin and the crystalline polyester resin is more than 40% by weight, the chargeability of the toner is deteriorated in some cases.

In the exemplary embodiment, the ratio of the crystalline polyester resin to the total of the amorphous polyester resin and the crystalline polyester resin is preferably from 13% by weight to 40% by weight, more preferably from 14% by weight to 30% by weight, and even more preferably from 15% by weight to 25% by weight.

In the exemplary embodiment, the temperature at which the storage elastic modulus G′ is 1.0×10⁸ Pa is set from 30° C. to 45° C. When the temperature at which the storage elastic modulus G′ is 1.0×10⁸ Pa is set to be lower than 30° C., the thermal storage properties are deteriorated in some cases. On the other hand, when the temperature at which the storage elastic modulus G′ is 1.0×10⁸ Pa is set to be higher than 45° C., the low temperature fixability is deteriorated in some cases. The temperature at which the storage elastic modulus G′ is 1.0×10⁸ Pa is preferably from 30° C. to 40° C.

In the exemplary embodiment, the reason why the temperature at which the storage elastic modulus G′ is 1.0×10⁸ Pa draws attention is that there is correlation between the fixing temperature of the toner and the temperature at which the storage elastic modulus G′ is 1.0×10⁸ Pa and thus the fixing temperature of the toner is indirectly defined by defining the temperature at which the storage elastic modulus G′ is 1.0×10⁸ Pa.

In the exemplary embodiment, in order to set the temperature at which the storage elastic modulus G′ is 1.0×10⁸ Pa within a range of 30° C. to 45° C., for example, the following method may be used.

It is effective to adjust the compatibility between the amorphous polyester resin and the crystalline polyester resin and the temperature may be adjusted to have a value within the above-described range by adjusting the monomer composition and ratio of each of the amorphous polyester resin and the crystalline polyester resin. For example, it is effective to use an index such as an SP value in the adjustment of the compatibility. In addition, the use of plural kinds of amorphous polyester resins and crystalline polyester resins is also an effective method.

In the exemplary embodiment, the storage elastic modulus G′ is measured using a rheometer (ARES, manufactured by TA instruments). The measurement is carried out by setting a sample to a sample holder at a temperature rise rate of 1° C./min, a frequency of 1 Hz, a strain of 1% or less, and a detection torque within a range of measurement guaranteed value. The size of the sample holder is adjusted to 8 mm and 20 mm as necessary. The change in the storage elastic modulus G′ (Pa) according to the change in the temperature is obtained. The analysis is carried out using software as a standard for the viscoelasticity measuring apparatus.

In the exemplary embodiment, a storage elastic modulus G′(B) (after thermal storage) at a temperature X′° C. at which the ratio [storage elastic modulus G′(B) (after thermal storage)/storage elastic modulus G′(A) (before thermal storage)] has the maximum value is set from 1.0×10⁸ Pa to 5.0×10⁸ Pa. When the storage elastic modulus G′(B) (after thermal storage) at the temperature X′° C. is less than 1.0×10⁸ Pa, the thermal storage properties are deteriorated in some cases. When the storage elastic modulus G′(B) (after thermal storage) at the temperature X′° C. is more than 5.0×10⁸ Pa, the low temperature fixability is deteriorated in some cases. The storage elastic modulus G′(B) (after thermal storage) at the temperature X′° C. is preferably from 1.0×10⁸ Pa to 4.0×10⁸ Pa, and more preferably from 1.5×10⁸ Pa to 3.0×10⁸ Pa.

In the exemplary embodiment, the storage elastic modulus G′(A) at the temperature X° C. before the toner is stored at the temperature X° C. (before thermal storage) and the storage elastic modulus G′(B) at the temperature X° C. after the toner is stored at the temperature X° C. for 2 hours (after thermal storage) are measured by the following method.

The temperature X° C. is changed from 30° C. to 60° C. at an interval of 2.5° C. and a plot in which the temperature X° C. is set as an X axis, and the value of the ratio [storage elastic modulus G′(B) (after thermal storage)/storage elastic modulus G′(A) (before thermal storage)] is set as a Y axis is obtained. A temperature X′° C. is obtained from the plot to specify a storage elastic modulus G′ (after thermal storage) at the temperature X′° C.

In the exemplary embodiment, the temperature X° C. at which the storage elastic modulus G′(B) (after thermal storage) is 1.0×10⁸ Pa or more is preferably from 50° C. to 60° C., and more preferably from 53° C. to 57° C. When the temperature X° C. at which the storage elastic modulus G′(B) (after thermal storage) is 1.0×10⁸ Pa or more is 50° C. or higher, the thermal storage properties are further improved. When the temperature X° C. at which the storage elastic modulus G′(B) (after thermal storage) is 1.0×10⁸ Pa or more is 60° C. or lower, the heat resistance of the toner is further improved.

Generally, the crystalline polyester in the toner is crystallized with time and heating stress and the state of the polyester is changed. In the exemplary embodiment, the reason why the value of the storage elastic modulus G′(B) (after thermal storage) at the temperature X° C. draws attention is that it has been found that both heat resistance and low temperature fixability may be achieved by controlling the change in the state of the toner against heat.

In the exemplary embodiment, in order to set the storage elastic modulus G′(B) (after thermal storage) at the temperature X′° C. to have a value within a range of 1.0×10⁸ Pa to 5.0×10⁸ Pa, for example, the following method may be used.

It is effective to adjust the compatibility between the amorphous polyester resin and the crystalline polyester resin and the storage elastic modulus may be adjusted to have a value within the above-described range by adjusting the monomer composition and ratio of each of the amorphous polyester resin and the crystalline polyester resin. For example, it is effective to use an index such as an SP value in the adjustment of the compatibility. In addition, the use of plural kinds of amorphous polyester resins and crystalline polyester resins is also an effective manner.

In the exemplary embodiment, an absolute value of a difference between an SP value of the amorphous polyester resin and an SP value of the crystalline polyester resin is preferably from 0.15 to 0.30, and more preferably from 0.20 to 0.30. When the absolute value of the difference between the SP value of the amorphous polyester resin and the SP value of the crystalline polyester resin is 0.15 or more, the thermal storage properties are further improved. When the absolute value of the difference between the SP value of the amorphous polyester resin and the SP value of the crystalline polyester resin is 0.30 or less, the low temperature fixability is further improved.

In the exemplary embodiment, the SP values of amorphous polyester resins when two or more kinds of amorphous polyester resins are used as the amorphous polyester resin refer to a weight average value of the SP values of each amorphous polyester resin. The SP values of the crystalline polyester resins when two or more kinds of crystalline polyester resins are used as the crystalline polyester resin refer to a weight average value of the SP value of each crystalline polyester resin.

There are various methods for calculating the SP value (solubility parameter), such as the Small method and the Fedors method. The Fedors method is used for calculating the solubility parameter in the exemplary embodiment. The SP value in this case is defined by the following equation (1).

$$SP = \sqrt{\frac{Δ E}{V}} = \sqrt{\frac{{\sum }_{i} Δ ei}{{\sum }_{i} Δ vi}} \qquad Equation ( 1 )$$

In the equation (1), SP represents the solubility parameter, ΔE represents the aggregation energy (cal/mol), V represents the mole volume (cm³/mol), Δei represents the evaporation energy of the i-th atom or atomic group (cal/atom or atomic group), Δvi represents the mole volume of the i-th atom or atomic group (cm³/atom or atomic group), and i represents an integer of 1 or more.

The SP value represented by the equation (1) is calculated so as to have cal^{1/2}/cm^{3/2} as the unit by practice, and it is represented by no dimension. Additionally, in the exemplary embodiment, since the relative difference of the SP values between the two compounds is meaningful, a value calculated according to the above-mentioned practice is used and represented by no dimension in the exemplary embodiment.

For reference, in the case where the SP value represented by the equation (1) is converted to the SI unit (J^{1/2}/m^{3/2}), the value is multiplied by 2046.

Hereinafter, the details of the toner according to the exemplary embodiment will be described.

The toner according to the exemplary embodiment includes toner particles and, optionally, an external additive.

Toner Particles

The toner particles each include a binder resin, optionally, a colorant, a release agent, and other additives.

Binder Resin

The toner according to the exemplary embodiment contains at least the amorphous polyester resin and the crystalline polyester resin as a binder resin.

The content of the amorphous polyester resin to be used may be within the range of 50% by weight to 88% by weight (preferably from 60% by weight to 80% by weight) with respect to the total binder resin.

The term “crystallinity” of the resin means that, in differential scanning calorimetry (DSC), the resin exhibits a distinct endothermic peak instead of stepwise endothermic change. Specifically, the resin has an endothermic peak having a half width of 10° C. or lower when measured at a temperature rise rate of 10 (° C./min).

On the other hand, the term “amorphousness” of the resin means that the resin has a half width of higher than 10° C., exhibits stepwise endothermic change, or does not exhibit a distinct endothermic peak.

Amorphous Polyester Resin

Examples of the amorphous polyester resin include a condensation polymer of a polyvalent carboxylic acid and a polyol. A commercially available product or a synthesized product may be used as the amorphous polyester resin.

Examples of the polyvalent carboxylic acid include aliphatic dicarboxylic acids (such as oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (such as cyclohexane dicarboxylic acid), aromatic dicarboxylic acids (such as terephthalic acid, isophthalic acid, phthalic acid, and naphthalene dicarboxylic acid), anhydrides thereof, or lower alkyl esters (having, for example, from 1 to 5 carbon atoms) thereof. Among these, for example, aromatic dicarboxylic acids are preferable as the polyvalent carboxylic acid.

As the polyvalent carboxylic acid, a tri- or higher-valent carboxylic acid having a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used singly or in combination of two or more kinds thereof.

Examples of the polyol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as ethylene oxide adduct of bisphenol A and propylene oxide adduct of bisphenol A). Among these, for example, aromatic diols and alicyclic diols are preferable, and aromatic diols are more preferable as the polyol.

As the polyol, a tri- or higher-valent polyol having a crosslinked structure or a branched structure may be used in combination with diol. Examples of the tri- or higher-valent polyol include glycerin, trimethylolpropane, and pentaerythritol.

The polyols may be used singly or in combination of two or more kinds thereof.

The glass transition temperature (Tg) of the amorphous polyester resin is preferably from 50° C. to 80° C., and more preferably from 50° C. to 65° C.

The glass transition temperature is obtained from a DSC curve obtained by differential scanning calorimetry (DSC). More specifically, the glass transition temperature is obtained from “extrapolated glass transition onset temperature” described in the method of obtaining a glass transition temperature in JIS K-7121-1987 “testing methods for transition temperatures of plastics”.

The weight average molecular weight (Mw) of the amorphous polyester resin is preferably from 5,000 to 1,000,000, and more preferably from 7,000 to 500,000.

The number average molecular weight (Mn) of the amorphous polyester resin is preferably from 2,000 to 100,000.

The molecular weight distribution Mw/Mn of the amorphous polyester resin is preferably from 1.5 to 100, and more preferably from 2 to 60.

The weight average molecular weight and the number average molecular weight are measured by gel permeation chromatography (GPC). The molecular weight measurement by GPC is performed using HLC-8120GPC which is GPC manufactured by Tosoh Corporation as a measuring device, TSK-GEL SUPER HM-M (15 cm) which is a column manufactured by Tosoh Corporation, and a THF solvent. The weight average molecular weight and the number average molecular weight are calculated using a molecular weight calibration curve plotted from a monodisperse polystyrene standard sample from the results of the above measurement.

In the exemplary embodiment, two or more kinds of amorphous polyester resins may be used. In this case, the absolute value of the difference between the SP value of the amorphous polyester resin having the largest SP value and the SP value of the amorphous polyester resin having the smallest SP value is preferably 0.25 or less, more preferably from 0.01 to 0.25, and even more preferably from 0.10 to 0.25. When the absolute value of the difference of the SP values is 0.25 or less, it is possible to adjust the compatibility between the crystalline polyester resin and the amorphous polyester resin within an appropriate range.

The amorphous polyester resin may be obtained by a known preparing method. Specific examples thereof include a method of conducting a reaction at a polymerization temperature set from 180° C. to 230° C., as necessary, under reduced pressure in the reaction system, while removing water or alcohol that is generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in the copolymerization reaction, the monomer having poor compatibility and an acid or an alcohol to be polycondensed with the monomer may be condensed in advance and then polycondensed with the main component.

In the exemplary embodiment, examples of a method of adjusting the SP value of the amorphous polyester resin include a method of selecting the kind of the polyvalent carboxylic acid and polyol constituting the amorphous polyester resin so that the amorphous polyester resin has a preferable SP value.

Crystalline Polyester Resin

Examples of the crystalline polyester resin include a polycondensate of a polyvalent carboxylic acid and a polyol. A commercially available product or a synthesized product may be used as the crystalline polyester resin.

Here, in order to easily form a crystal structure, as the crystalline polyester resin, a polycondensate using a polymerizable monomer having a linear aliphatic group is preferably used rather than a polymerizable monomer having an aromatic group.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides thereof, or lower alkyl esters (having, for example, from 1 to 5 carbon atoms) thereof.

As the polyvalent carboxylic acid, a tri- or higher-valent carboxylic acid having a crosslinked structure or a branched structure may be used in combination with a dicarboxylic acid. Examples of the trivalent carboxylic acid include aromatic carboxylic acids (such as 1,2,3-benzenetricarboxylic acid, 1,2,4-benzenetricarboxylic acid, and 1,2,4-naphthalenetricarboxylic acid), anhydrides thereof, or lower alkyl esters (having, for example, from 1 to 5 carbon atoms) thereof.

As the polyvalent carboxylic acid, a dicarboxylic acid having a sulfonic acid group or a dicarboxylic acid having an ethylenic double bond may be used in combination with these dicarboxylic acids.

The polyvalent carboxylic acids may be used singly or in combination of two or more kinds thereof.

Examples of the polyol include aliphatic diols (such as linear aliphatic diols having from 7 to 20 carbon atoms in a main chain part). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

As the polyol, a tri- or higher-valent polyol having a crosslinked structure or a branched structure may be used in combination with diol. Examples of the tri- or higher-valent polyol include glycerin, trimethylolethane, trimethylolpropane, and pentaerythritol.

The polyols may be used singly or in combination of two or more kinds thereof.

Here, in the polyol, the content of the aliphatic diol may be 80% by mole or more, and is preferably 90% by mole or more.

The melting temperature of the crystalline polyester resin is preferably from 72° C. to 80° C., more preferably from 72° C. to 78° C., and even more preferably from 72° C. to 76° C.

When the melting temperature of the crystalline polyester resin is 72° C. or higher, the thermal storage properties are further improved. When the melting temperature of the crystalline polyester resin is 80° C. or lower, the low temperature fixability is further improved.

The melting temperature is obtained from “melting peak temperature” described in the method of obtaining a melting temperature in JIS K7121-1987 “testing methods for transition temperatures of plastics”, from a DSC curve obtained by differential scanning calorimetry (DSC).

The weight average molecular weight (Mw) of the crystalline polyester resin is preferably from 10,000 to 45,000.

For example, the crystalline polyester resin may be obtained by a known preparing method as in the case of the amorphous polyester resin.

In the exemplary embodiment, examples of a method of adjusting the SP value of the crystalline polyester resin include a method of selecting the kind of the polyvalent carboxylic acid and polyol constituting the crystalline polyester resin so that the crystalline polyester resin has a preferable SP value.

In the exemplary embodiment, as the binder resin, resins other than the amorphous polyester resin and the crystalline polyester resin may be used. Examples of the other binder resins include vinyl resins formed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene), or copolymers obtained by combining two or more kinds of these monomers.

As the binder resin, there are also exemplified non-vinyl resins such as epoxy resins, polyurethane resins, polyamide resins, cellulose resins, polyether resins, and modified rosin, mixtures thereof with the above-described vinyl resins, or graft polymers obtained by polymerizing a vinyl monomer with the coexistence of such non-vinyl resins.

These other binder resins may be used singly or in combination of two or more kinds thereof.

In the exemplary embodiment, as the other binder resins, a styrene-(meth)acrylic copolymer resin may be used. When the styrene-(meth)acrylic copolymer resin is used as the other binder resin, the fixing characteristics such as hot offset and the thermal storage properties are further improved.

When the styrene-(meth)acrylic copolymer resin is used as the other binder resin, the ratio of the styrene-(meth)acrylic copolymer resin to the binder resin is preferably from 5% by weight to 25% by weight, more preferably from 5% by weight to 20% by weight, and even more preferably from 10% by weight to 15% by weight. When the ratio of the styrene-(meth)acrylic copolymer resin to the binder resin is 5% by weight or more, the fixing characteristics such as hot offset and the thermal storage properties are further improved. When the ratio of the styrene-(meth)acrylic copolymer resin to the binder resin is 25% by weight or less, the low temperature fixability is further improved.

In the exemplary embodiment, the expression “(meth)acryl” means acryl or methacryl.

The styrene-(meth)acrylic copolymer resin may be synthesized by various polymerization methods such as solution polymerization, precipitation polymerization, suspension polymerization, block polymerization, and emulsion polymerization. In addition, the polymerization reaction may be conducted by a known operation of a batch type, a semi-continuous type, a continuous type, or the like.

The content of the binder resin is preferably from 40% by weight to 95% by weight, more preferably from 50% by weight to 90% by weight, and even more preferably from 60% by weight to 85% by weight with respect to the total toner particles.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorants may be used singly or in combination of two or more kinds thereof.

As necessary, the colorant may be surface-treated or used in combination with a dispersant. Plural kinds of colorants may be used in combination.

The content of the colorant is, for example, preferably from 1% by weight to 30% by weight, and more preferably from 3% by weight to 15% by weight with respect to the total toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited to the above examples.

The melting temperature of the release agent is preferably from 50° C. to 110° C., and more preferably from 60° C. to 100° C.

The melting temperature is obtained from “melting peak temperature” described in the method of obtaining a melting temperature in JIS K-7121-1987 “testing methods for transition temperatures of plastics”, from a DSC curve obtained by differential scanning calorimetry (DSC).

The content of the release agent is, for example, preferably from 1% by weight to 20% by weight, and more preferably from 5% by weight to 15% by weight with respect to the total toner particles.

Other Additives

Examples of other additives include known additives such as a magnetic material, a charge-controlling agent, and an inorganic powder. The toner particles include these additives as internal additives.

Characteristics of Toner Particles

The toner particles may have a single-layer structure, or a so-called core-shell structure composed of a core (core particle) and a coating layer (shell layer) that is coated on the core.

Here, toner particles having a core-shell structure may be composed of, for example, a core configured to include a binder resin, and as necessary, other additives such as a colorant and a release agent and a coating layer configured to include a binder resin.

The volume average particle diameter (D50v) of the toner particles is preferably from 2 μm to 10 μm, and more preferably from 4 μm to 8 μm.

Various average particle diameters and various particle size distribution indices of the toner particles are measured using a COULTER MULTISIZER II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkylbenzene sulfonate) as a dispersant. The obtained material is added to from 100 ml to 150 ml of the electrolyte.

The electrolyte in which the sample is suspended is subjected to a dispersion treatment using an ultrasonic disperser for 1 minute, and a particle size distribution of particles having a particle diameter of from 2 μm to 60 μm is measured by a COULTER MULTISIZER II using an aperture having an aperture diameter of 100 μm. 50,000 particles are sampled.

The cumulative distributions by volume and by number are drawn from the side of the smallest diameter based on particle size ranges (channels), which are separated based on the measured particle size distribution. The particle diameter when the cumulative percentage is 16% is defined as a volume particle diameter D16v and a number particle diameter D16p, while the particle diameter when the cumulative percentage is 50% is defined as a volume average particle diameter D50v and a cumulative number average particle diameter D50p. Furthermore, the particle diameter when the cumulative percentage is 84% is defined as a volume particle diameter D84v and a number particle diameter D84p.

Using these, a volume average particle size distribution index (GSDv) is calculated as (D84v/D16v)^{1/2}, while a number average particle size distribution index (GSDp) is calculated as (D84p/D16p)^{1/2}.

The shape factor SF1 of the toner particles is preferably from 110 to 150, and more preferably from 120 to 140.

The shape factor SF1 is obtained using the following equation.

SF1=(ML²/A)×(π/4)×100 Equation:

In the equation, ML represents an absolute maximum length of a toner particle, and A represents a projected area of a toner particle, respectively.

Specifically, the shape factor SF1 is numerically converted mainly by analyzing a microscopic image or a scanning electron microscopic (SEM) image by the use of an image analyzer, and calculated as follows. That is, an optical microscopic image of particles dispersed on a surface of a glass slide is input to an image analyzer LUZEX (manufactured by Nireco Corporation) through a video camera to obtain the maximum lengths and projected areas of 100 particles, values of SF1 are calculated using the above equation, and an average value thereof is obtained.

External Additives

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surfaces of the inorganic particles as an external additive may preferably be treated with a hydrophobizing agent. The treatment with a hydrophobizing agent is performed by, for example, dipping the inorganic particles in a hydrophobizing agent. The hydrophobizing agent is not particularly limited. Examples of the hydrophobizing agent include a silane coupling agent, silicone oil, a titanate coupling agent, and an aluminum coupling agent. These may be used singly or in combination of two or more kinds thereof.

The amount of the hydrophobizing agent is generally, for example, from 1 part by weight to 10 parts by weight with respect to 100 parts by weight of the inorganic particles.

Examples of the external additive also include resin particles (resin particles of polystyrene, polymethyl methacrylate (PMMA), melamine resin, and the like) and a cleaning aid (such as metal salt of higher fatty acid represented by zinc stearate, and fluorine-containing polymer particles).

The amount of the external additive to be externally added is, for example, preferably from 0.01% by weight to 5% by weight, and more preferably from 0.01% by weight to 2.0% by weight with respect to the toner particles.

Toner Preparing Method

Next, a method of preparing a toner according to this exemplary embodiment will be described.

The toner according to this exemplary embodiment is obtained by externally adding an external additive to toner particles after manufacturing of the toner particles.

The toner particles may be manufactured using any one of a dry preparing method (for example, kneading and pulverizing method) and a wet preparing method (for example, aggregation and coalescence method, suspension and polymerization method, and dissolution and suspension method). The toner particle preparing method is not particularly limited to these preparing methods, and a known preparing method is employed.

Among these, the toner particles are preferably obtained by an aggregation and coalescence method.

Specifically, for example, when the toner particles are manufactured by an aggregation and coalescence method, the toner particles are manufactured through the processes of: preparing a resin particle dispersion in which resin particles as a binder resin are dispersed (resin particle dispersion preparation process); aggregating the resin particles (other particles, as necessary) in the resin particle dispersion (in the dispersion after mixing with other particle dispersions, as necessary) to form aggregated particles (aggregated particle forming process); and heating the aggregated particle dispersion in which the aggregated particles are dispersed, to coalesce the aggregated particles, thereby forming toner particles (coalescence process).

Hereinafter, each of the processes will be described in detail.

In the following description, a method of obtaining toner particles containing a colorant and a release agent will be described. However, the colorant and the release agent are used as necessary. Additives other than the colorant and the release agent may be used.

Resin Particle Dispersion Preparation Process

First, for example, a colorant particle dispersion in which colorant particles are dispersed and a release agent particle dispersion in which release agent particles are dispersed are prepared together with a resin particle dispersion in which resin particles as a binder resin are dispersed.

Here, the resin particle dispersion is prepared by, for example, dispersing resin particles by a surfactant in a dispersion medium.

Examples of the dispersion medium that is used for the resin particle dispersion include aqueous mediums.

Examples of the aqueous mediums include water such as distilled water and ion exchange water, and alcohols. These may be used singly or in combination of two or more kinds thereof.

Examples of the surfactant include anionic surfactants such as sulfate, sulfonate, phosphate, and soap-based anionic surfactants; cationic surfactants such as amine salt and quaternary ammonium salt cationic surfactants; and nonionic surfactants such as polyethylene glycol, alkyl phenol ethylene oxide adduct, and polyol nonionic surfactants. Among these, anionic surfactants and cationic surfactants are particularly exemplified. Nonionic surfactants may be used in combination with anionic surfactants or cationic surfactants.

The surfactants may be used singly or in combination of two or more kinds thereof.

Regarding the resin particle dispersion, as a method of dispersing the resin particles in the dispersion medium, for example, a common dispersing method using, for example, a rotary shearing type homogenizer, or a ball mill, a sand mill, or a DYNO mill having media are exemplified. Depending on the kind of the resin particles, resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); converting the resin (so-called phase inversion) from W/O to O/W by adding an aqueous medium (W phase) to form a discontinuous phase, thereby dispersing the resin as particles in the aqueous medium.

The volume average particle diameter of the resin particles that are dispersed in the resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the smallest diameter with respect to particle size ranges (channels) separated using the particle size distribution obtained by the measurement of a laser diffraction type particle size distribution measuring device (for example, LA-700, manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

The content of the resin particles that are contained in the resin particle dispersion is, for example, preferably from 5% by weight to 50% by weight, and more preferably from 10% by weight to 40% by weight.

For example, the colorant dispersion and the release agent dispersion are also prepared in the same manner as in the case of the resin particle dispersion. That is, the particles in the resin particle dispersion are the same as the colorant particles that are dispersed in the colorant dispersion and the release agent particles that are dispersed in the release agent dispersion, in terms of the volume average particle diameter, the dispersion medium, the dispersing method, and the content of the particles.

Aggregated Particle Forming Process

Next, the colorant particle dispersion and the release agent dispersion are mixed together with the resin particle dispersion.

The resin particles, the colorant particles, and the release agent particles are heterogeneously aggregated in the mixed dispersion to form aggregated particles with a diameter close to a target toner particle diameter that include the resin particles, the colorant particles, and the release agent particles.

Specifically, for example, an aggregating agent is added to the mixed dispersion and a pH of the mixed dispersion is adjusted to acidic (for example, the pH is from 2 to 5). If necessary, a dispersion stabilizer is added. Then, the mixed dispersion is heated at a glass transition temperature of the resin particles (specifically, for example, from a temperature 30° C. lower than the glass transition temperature of the resin particles to a temperature 10° C. lower than the glass transition temperature) to aggregate the particles dispersed in the mixed dispersion, thereby forming the aggregated particles.

In the aggregated particle forming process, for example, the aggregating agent may be added at room temperature (for example, 25° C.) under stirring of the mixed dispersion using a rotary shearing type homogenizer, the pH of the mixed dispersion may be adjusted to acidic (for example, the pH is from 2 to 5), a dispersion stabilizer may be added as necessary, and the heating may be then performed.

Examples of the aggregating agent include a surfactant having an opposite polarity of the polarity of the surfactant that is used as the dispersant to be added to the mixed dispersion, such as inorganic metal salts and di- or higher-valent metal complexes. Particularly, when a metal complex is used as the aggregating agent, the amount of the surfactant to be used is reduced and charging characteristics are improved.

As necessary, an additive may be used which forms a complex or a similar bond with the metal ions of the aggregating agent. A chelating agent is preferably used as the additive.

Examples of the inorganic metal salts include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent to be added is, for example, preferably from 0.01 part by weight to 5.0 parts by weight, and more preferably from 0.1 part by weight to less than 3.0 parts by weight with respect to 100 parts by weight of the resin particles.

Coalescence Process

Next, the aggregated particle dispersion in which the aggregated particles are dispersed is heated at, for example, a temperature that is equal to or higher than the glass transition temperature of the resin particles (for example, a temperature that is higher than the glass transition temperature of the resin particles by 10° C. to 30° C.) to coalesce the aggregated particles and form toner particles.

Toner particles are obtained through the above processes.

After the aggregated particle dispersion in which the aggregated particles are dispersed is obtained, toner particles may be manufactured through the processes of: further mixing the resin particle dispersion in which the resin particles are dispersed with the aggregated particle dispersion to conduct aggregation so that the resin particles are further attached to the surfaces of the aggregated particles, thereby forming second aggregated particles; and coalescing the second aggregated particles by heating a second aggregated particle dispersion in which the second aggregated particles are dispersed, thereby forming toner particles having a core-shell structure.

Here, after the coalescence process ends, the toner particles formed in the solution are subjected to a washing process, a solid-liquid separation process, and a drying process, that are well known, and thus dry toner particles are obtained.

In the washing process, preferably, displacement washing with ion exchange water may be sufficiently performed from the viewpoint of chargeability. In addition, the solid-liquid separation process is not particularly limited, but suction filtration, pressure filtration, or the like may be preferably performed from the viewpoint of productivity. Furthermore, the method for the drying process is also not particularly limited, but freeze drying, flash jet drying, fluidized drying, vibration type fluidized drying, or the like may be preferably performed from the viewpoint of productivity.

In the exemplary embodiment, after the toner particles are prepared, under preset temperature and heating time conditions, the toner particles may be subjected to an annealing treatment. Thus, the physical properties of the toner particles may be adjusted so that the storage elastic modulus G′(B) (after thermal storage) at the temperature X′° C. is from 1.0×10⁸ Pa to 5.0×10⁸ Pa.

The toner according to the exemplary embodiment is manufactured by, for example, adding an external additive to dry toner particles that have been obtained, and mixing the components. The mixing may preferably be performed using, for example, a V-blender, a HENSCHEL mixer, a LODIGE mixer, or the like. Furthermore, as necessary, coarse toner particles may be removed using a vibrating sieving machine, a wind classifier, or the like.

Electrostatic Charge Image Developer

An electrostatic charge image developer according to this exemplary embodiment includes at least the toner according to this exemplary embodiment.

The electrostatic charge image developer according to the exemplary embodiment may be a single-component developer including only the toner according to the exemplary embodiment, or a two-component developer obtained by mixing the toner and a carrier.

The carrier is not particularly limited, and known carriers are exemplified. Examples of the carrier include a coated carrier in which surfaces of cores formed of a magnetic particle are coated with a coating resin; a magnetic particle dispersion type carrier in which magnetic particles are dispersed and blended in a matrix resin; and a resin impregnation type carrier in which a porous magnetic particle is impregnated with a resin.

The magnetic particle dispersion type carrier and the resin impregnation type carrier may be carriers in which constituent particles of the carrier are cores and the cores are coated with a coating resin.

Examples of the magnetic particle include magnetic metals such as iron, nickel, and cobalt, and magnetic oxides such as ferrite and magnetite.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

The coating resin and the matrix resin may contain other additives such as a conductive material.

Here, a coating method using a coating layer forming solution in which a coating resin, and as necessary, various additives are dissolved in an appropriate solvent is used to coat the surface of a core with the coating resin. The solvent is not particularly limited, and may be selected in consideration of the coating resin to be used, coating suitability, and the like.

Specific examples of the resin coating method include a dipping method of dipping cores in a coating layer forming solution, a spraying method of spraying a coating layer forming solution to surfaces of cores, a fluidized bed method of spraying a coating layer forming solution in a state in which cores are allowed to float by flowing air, and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100 (toner:carrier), and more preferably from 3:100 to 20:100.

Image Forming Apparatus and Image Forming Method

An image forming apparatus and an image forming method according to exemplary embodiments will be described.

The image forming apparatus according to this exemplary embodiment includes an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member with the electrostatic charge image developer to form a toner image, a transfer unit that transfers the toner image formed on the surface of the image holding member onto a surface of a recording medium, and a fixing unit that fixes the toner image transferred onto the surface of the recording medium. As the electrostatic charge image developer, the electrostatic charge image developer according to this exemplary embodiment is applied.

In the image forming apparatus according to this exemplary embodiment, an image forming method (image forming method according to this exemplary embodiment) including a charging process of charging a surface of an image holding member, an electrostatic charge image forming process of forming an electrostatic charge image on the charged surface of the image holding member, a developing process of developing the electrostatic charge image formed on the surface of the image holding member with the electrostatic charge image developer according to this exemplary embodiment to form a toner image, a transfer process of transferring the toner image formed on the surface of the image holding member onto a surface of a recording medium, and a fixing process of fixing the toner image transferred onto the surface of the recording medium is performed.

As the image forming apparatus according to this exemplary embodiment, a known image forming apparatus is applied, such as a direct transfer type apparatus that directly transfers a toner image formed on a surface of an image holding member onto a recording medium; an intermediate transfer type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus including a cleaning unit that cleans, after transfer of a toner image and before charging, a surface of an image holding member; or an apparatus including an erasing unit that erases, after transfer of a toner image and before charging, a surface of an image holding member by irradiation with erasing light for erasing.

In the case of an intermediate transfer type apparatus, a transfer unit is configured to have, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to this exemplary embodiment, for example, a part including the developing unit may have a cartridge structure (process cartridge) that is detachable from the image forming apparatus. As the process cartridge, for example, a process cartridge that include the developing unit that accommodates the electrostatic charge image developer according to this exemplary embodiment is preferably used.

Hereinafter, an example of the image forming apparatus according to this exemplary embodiment will be described. However, the image forming apparatus is not limited thereto. Main parts shown in the drawings will be described, and descriptions of other parts will be omitted.

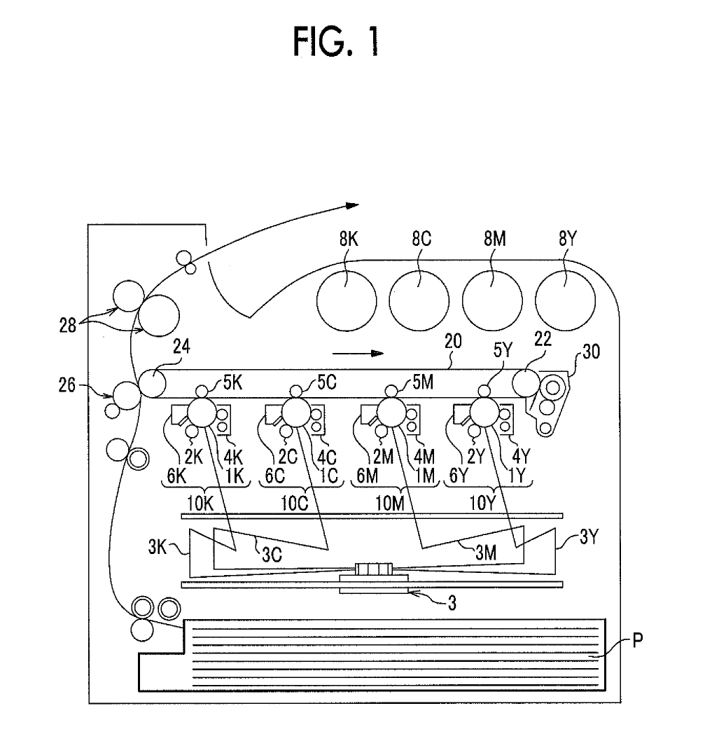

FIG. 1 is a schematic diagram showing a configuration of the image forming apparatus according to this exemplary embodiment.

The image forming apparatus shown in FIG. 1 is provided with first to fourth electrophotographic image forming units 10Y, 10M, 10C, and 10K (image forming units) that output yellow (Y), magenta (M), cyan (C), and black (K) images based on color-separated image data, respectively. These image forming units (hereinafter, may be simply referred to as “units”) 10Y, 10M, 10C, and 10K are arranged side by side at predetermined intervals in a horizontal direction. These units 10Y, 10M, 10C, and 10K may be process cartridges that are detachable from the image forming apparatus.

An intermediate transfer belt 20 as an intermediate transfer member is installed above each of the units 10Y, 10M, 10C, and 10K in the drawing to extend through each unit. The intermediate transfer belt 20 is wound on a driving roll 22 and a support roll 24 contacting the inner surface of the intermediate transfer belt 20, which are separated from each other on the left and right sides in the drawing, and travels in a direction toward the fourth unit 10K from the first unit 10Y. The support roll 24 is pressed in a direction away from the driving roll 22 by a spring or the like (not shown), and a tension is given to the intermediate transfer belt 20 wound on both of the rolls. In addition, an intermediate transfer member cleaning device 30 opposed to the driving roll 22 is provided on a surface of the intermediate transfer belt 20 on the image holding member side.

In addition, developing devices (developing units) 4Y, 4M, 4C, and 4K of the units 10Y, 10M, 10C, and 10K are supplied with four color toners, that is, a yellow toner, a magenta toner, a cyan toner, and a black toner contained in toner cartridges 8Y, 8M, 8C, and 8K, respectively.

The first to fourth units 10Y, 10M, 10C, and 10K have the same configuration and thus, only the first unit 10Y that is disposed on the upstream side in a traveling direction of the intermediate transfer belt to form a yellow image will be representatively described. The same parts as in the first unit 10Y will be denoted by the reference numerals with magenta (M), cyan (C), and black (K) added instead of yellow (Y), and descriptions of the second to fourth units 10M, 10C, and 10K will be omitted.

The first unit 10Y has a photoreceptor 1Y acting as an image holding member. Around the photoreceptor 1Y, a charging roll 2Y (an example of the charging unit) that charges a surface of the photoreceptor 1Y to a predetermined potential, an exposure device 3 (an example of the electrostatic charge image forming unit) that exposes the charged surface with laser beams 3Y based on a color-separated image signal to form an electrostatic charge image, a developing device 4Y (an example of the developing unit) that supplies a charged toner to the electrostatic charge image to develop the electrostatic charge image, a primary transfer roll 5Y (an example of the primary transfer unit) that primarily transfers the developed toner image onto the intermediate transfer belt 20, and a photoreceptor cleaning device 6Y (an example of the cleaning unit) that removes the toner remaining on the surface of the photoreceptor 1Y after the primary transfer, are arranged in sequence.

The primary transfer roll 5Y is disposed inside the intermediate transfer belt 20 to be provided at a position opposed to the photoreceptor 1Y. Furthermore, bias supplies (not shown) that apply a primary transfer bias are connected to the primary transfer rolls 5Y, 5M, 5C, and 5K, respectively. Each bias supply changes a transfer bias that is applied to each primary transfer roll under the control of a controller (not shown).

Hereinafter, an operation of forming a yellow image in the first unit 10Y will be described.

First, before the operation, the surface of the photoreceptor 1Y is charged to a potential of −600 V to −800 V by the charging roll 2Y.

The photoreceptor 1Y is formed by laminating a photosensitive layer on a conductive substrate (for example, volume resistivity at 20° C.: 1×10⁻⁶ Ωcm or less). The photosensitive layer typically has high resistance (that is, about the same resistance as that of a general resin), but has properties in which when the laser beams 3Y are applied, the specific resistance of a part irradiated with the laser beams changes. Accordingly, the laser beams 3Y are output to the charged surface of the photoreceptor 1Y via the exposure device 3 in accordance with image data for yellow sent from the controller (not shown). The laser beams 3Y are applied to the photosensitive layer on the surface of the photoreceptor 1Y, and thus, an electrostatic charge image of a yellow image pattern is formed on the surface of the photoreceptor 1Y.

The electrostatic charge image is an image that is formed on the surface of the photoreceptor 1Y by charging, and is a so-called negative latent image, that is formed by applying the laser beams 3Y to the photosensitive layer so that the specific resistance of the irradiated part is lowered to cause charges to flow on the surface of the photoreceptor 1Y, while charges remain on a part to which the laser beams 3Y are not applied.

The electrostatic charge image that is formed on the photoreceptor 1Y is rotated up to a predetermined developing position with the travelling of the photoreceptor 1Y. The electrostatic charge image on the photoreceptor 1Y is visualized (developed) as a toner image at the developing position by the developing device 4Y.

The developing device 4Y accommodates, for example, an electrostatic charge image developer including at least a yellow toner and a carrier. The yellow toner is frictionally charged by being stirred in the developing device 4Y to have a charge with the same polarity (negative polarity) as the charge that is on the photoreceptor 1Y, and is thus held on the developer roll (an example of the developer holding member). By allowing the surface of the photoreceptor 1Y to pass through the developing device 4Y, the yellow toner is electrostatically attached to the latent image part having been erased on the surface of the photoreceptor 1Y, and thus, the latent image is developed with the yellow toner. Next, the photoreceptor 1Y having the yellow toner image formed thereon continuously travels at a predetermined rate and the toner image developed on the photoreceptor 1Y is transported to a predetermined primary transfer position.

When the yellow toner image on the photoreceptor 1Y is transported to the primary transfer position, a primary transfer bias is applied to the primary transfer roll 5Y and an electrostatic force toward the primary transfer roll 5Y from the photoreceptor 1Y acts on the toner image and thus, the toner image on the photoreceptor 1Y is transferred onto the intermediate transfer belt 20. The transfer bias applied at this time has the opposite polarity (+) of the toner polarity (−), and, for example, is controlled to +10 μA in the first unit 10Y by the controller (not shown).

On the other hand, the toner remaining on the photoreceptor 1Y is removed and collected by the photoreceptor cleaning device 6Y.

The primary transfer biases that are applied to the primary transfer rolls 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 10C, and 10K, and the toner images of respective colors are multiply-transferred in a superimposed manner.

The intermediate transfer belt 20 onto which the four color toner images have been multiply-transferred through the first to fourth units reaches a secondary transfer part that is composed of the intermediate transfer belt 20, the support roll 24 contacting the inner surface of the intermediate transfer belt, and a secondary transfer roll (an example of the secondary transfer unit) 26 disposed on the image holding surface side of the intermediate transfer belt 20. Meanwhile, a recording sheet P (an example of the recording medium) is supplied to a gap between the secondary transfer roll 26 and the intermediate transfer belt 20, that are brought into contact with each other, via a supply mechanism at a predetermined timing, and a secondary transfer bias is applied to the support roll 24. The transfer bias applied at this time has the same polarity (−) as the toner polarity (−), and an electrostatic force toward the recording sheet P from the intermediate transfer belt 20 acts on the toner image. Thus, the toner image on the intermediate transfer belt 20 is transferred onto the recording sheet P. In this case, the secondary transfer bias is determined depending on the resistance detected by a resistance detecting unit (not shown) that detects the resistance of the secondary transfer part, and the voltage is controlled.

Thereafter, the recording sheet P is fed to a pressure-contacting part (nip part) between a pair of fixing rolls in a fixing device 28 (an example of the fixing unit) so that the toner image is fixed to the recording sheet P, and thus a fixed image is formed.

Examples of the recording sheet P onto which a toner image is transferred include plain paper that is used in electrophotographic copying machines, printers, and the like. As a recording medium, an OHP sheet is also exemplified other than the recording sheet P.

The surface of the recording sheet P is preferably smooth in order to further improve smoothness of the image surface after fixing. For example, coating paper obtained by coating a surface of plain paper with a resin or the like, art paper for printing, and the like are preferably used.

The recording sheet P on which the fixing of the color image is completed is discharged toward a discharge part, and a series of the color image forming operations ends.

Process Cartridge and Toner Cartridge

A process cartridge according to this exemplary embodiment will be described.

The process cartridge according to this exemplary embodiment includes a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to this exemplary embodiment is not limited to the above-described configuration, and may be configured to include a developing device, and for example, as necessary, at least one selected from other units such as an image holding member, a charging unit, an electrostatic charge image forming unit, and a transfer unit.

Hereinafter, an example of the process cartridge according to this exemplary embodiment will be shown. However, the process cartridge is not limited thereto. Main parts shown in the drawings will be described, and descriptions of other parts will be omitted.

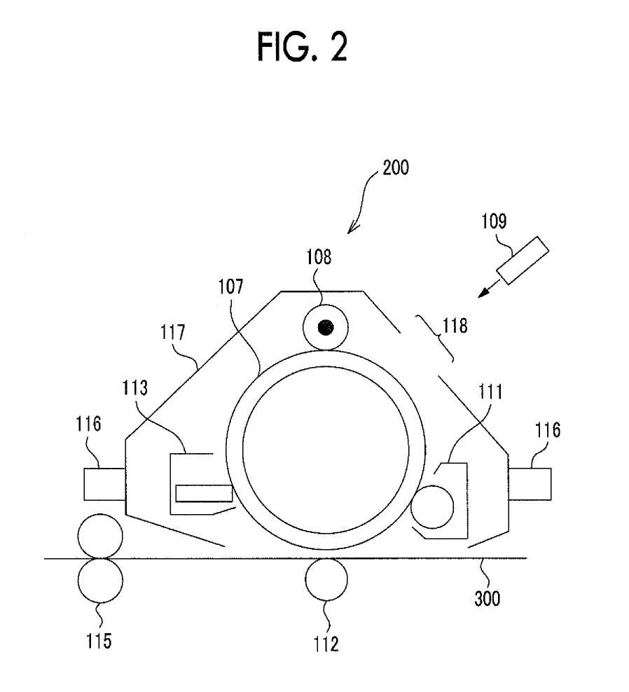

FIG. 2 is a schematic configuration view illustrating the process cartridge according to this exemplary embodiment.

A process cartridge 200 shown in FIG. 2 is formed as a cartridge having a configuration in which a photoreceptor 107 (an example of the image holding member), and a charging roll 108 (an example of the charging unit), a developing device 111 (an example of the developing unit), and a photoreceptor cleaning device 113 (an example of the cleaning unit), which are provided around the photoreceptor 107, are integrally combined and held by, for example, a housing 117 provided with a mounting rail 116 and an opening 118 for exposure.

In FIG. 2, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to this exemplary embodiment will be described.

The toner cartridge according to this exemplary embodiment is a toner cartridge including a container that accommodates the toner according to the exemplary embodiment and is detachable from an image forming apparatus. The toner cartridge accommodates a toner for replenishment to be supplied to the developing unit provided in the image forming apparatus.

The image forming apparatus shown in FIG. 1 has a configuration from which the toner cartridges BY, 8M, 8C, and 8K are detachable, and the developing devices 4Y, 4M, 4C, and 4K are connected to the toner cartridges corresponding to the respective developing devices (colors) with toner supply tubes (not shown), respectively. In addition, when the toner accommodated in the toner cartridge runs low, the toner cartridge is replaced.

### EXAMPLES

Hereinafter, this exemplary embodiment will be described in more detail using examples and comparative examples, but is not limited to these examples. Unless otherwise noted, “parts” and “%” are based on weight.

Weight Average Molecular Weight

The molecular weight of a binder resin or the like is measured on the following condition: “HLC-8120GPC (manufactured by TOSOH CORPORATION)” is used as GPC; two columns of “TSK-GEL SUPER HM-H (6.0 mm ID×15 cm, manufactured by TOSOH CORPORATION)” are used as columns; and THF (tetrahydrofuran) is used as an eluent. The experiment is performed on the following condition: the sample concentration is 0.5%; the flow rate is 0.6 mL/min; the sample injection amount is 10 μL; the measuring temperature is 40° C.; and the detector is an RI detector. The calibration curve is prepared with ten polystyrene standard samples of TSK Standards of “A-500”, “F-1”, “F-10”, “F-80”, “F-380”, “A-2500”, “F-4”, “F-40”, “F-128”, and “F-700” (manufactured by TOSOH CORPORATION).

Glass Transition Temperature and Melting Temperature

The Glass transition temperature and the melting temperature are measured by differential scanning calorimetry according to JIS K7121-1987. The measurement is performed as follows.

That is, first, a substance to be measured is set on a differential scanning calorimeter (trade name: DSC-50, manufactured by Shimadzu Corporation) provided with an automatic tangent processing system and after setting liquid nitrogen as a cooling medium, the substance is heated to 150° C. from 0° C. at a temperature rise rate of 10° C./min (first temperature rising process) to determine the relationship between temperature (° C.) and heat quantity (mW). Next, the substance is cooled to 0° C. at a temperature drop rate of −10° C./min and again heated to 150° C. at a temperature rise rate of 10° C./min (second temperature rising process) to collect data. Here, the toner is held at 0° C. and 150° C. each for 10 minutes.

In the measuring device, temperature correction at the detection unit is conducted using the melting temperature of the mixture of indium and zinc, and correction of the heat quantity is conducted using the heat of fusion of indium. A sample is put in an aluminum pan and the aluminum pan in which the sample is put and an empty aluminum pan for control are set.

The temperature at an intersection point of extensions of a base line and a rising line in an endothermic portion of the DSC curve obtained in the second temperature rising process is set as the glass transition temperature of the amorphous polyester resin.

The temperatures of the maximum peak out of peaks having an endothermic amount of 25 J/g or more in the DSC curve obtained in the second temperature rising process are set as the melting temperatures of the crystalline polyester resin and the release agent.

Acid Value

The acid value (AV) is measured as follows. A basic operation is performed according to JIS K-0070-1992.

A sample is obtained by removing insoluble components to THF from a resin in advance, or by extracting soluble components to a THF solvent using a Soxhlet extractor, and used. 1.5 g of the pulverized sample is precisely measured and put into a 300 ml beaker with 100 ml of mixed solution of toluene and ethanol (4/1) and dissolved. Potentiometric titration is performed with 0.1 mol/l of an ethanol solution of KOH, using an automatic titrator GT-100 (manufactured by Dia Instruments Co., Ltd). The amount of KOH solution used at this time is defined as A (ml). The blank is also measured and the amount of KOH solution used at this time is defined as B (ml). The acid value is calculated from the following equation (A) based on these values. In the equation (A), w represents a precisely measured amount of the sample and f represents a factor of KOH.

Acid value (mgKOH/g)={(A−B)×f×5.61}/w Equation (A)

Synthesis of Amorphous Polyester Resin 1 (Amo-1)
Bisphenol A ethylene oxide adduct: 150 parts
Bisphenol A propylene oxide adduct: 250 parts
Terephthalic acid: 100 parts
Tetrapropenyl succinic anhydride: 130 parts
Trimellitic acid: 15 parts

The above-described monomer components are put into a reaction vessel provided with a stirrer, a thermometer, a condenser and a nitrogen gas introducing tube. The reaction vessel is purged with dry nitrogen gas and then 0.3% of tin octanoate with respect to a total amount of the monomer components is added. The temperature is increased to 235° C. in a nitrogen gas stream over 1 hour and the mixture is allowed to react for 3 hours. The pressure inside the reaction vessel is reduced to 10.0 mmHg and the resultant is allowed to react under stirring. The reaction ends when a desired molecular weight is obtained.

The glass transition temperature of the obtained amorphous polyester resin 1 is 61° C., the weight average molecular weight is 42,000, and the acid value is 13 mgKOH/g. In addition, the SP value is 9.47.

Preparation of Amorphous Polyester Resin Dispersion 1
Amo-1: 100 parts
Methyl ethyl ketone: 60 parts
Isopropyl alcohol: 10 parts

The above-described components are put into a reaction vessel provided with a stirrer and dissolved at 60° C. After checking the dissolution, the temperature of the reaction vessel is cooled to 35° C. and then 3.5 parts of a 10% ammonia aqueous solution is added. Next, 300 parts of ion exchange water is added dropwise to the reaction vessel over 3 hours to prepare a polyester resin dispersion. Next, methyl ethyl ketone and isopropyl alcohol are removed by an evaporator to obtain an amorphous polyester resin dispersion 1.

Synthesis of Amorphous Polyester Resin 2 (Amo-2)

An amorphous polyester resin 2 is obtained in the same manner as in the synthesis of the amorphous polyester resin 1 except that the following monomer components are used.
Bisphenol A ethylene oxide adduct: 30 parts
Bisphenol A propylene oxide adduct: 270 parts
Terephthalic acid: 60 parts
Fumaric acid: 40 parts
Tetrapropenyl succinic anhydride: 40 parts

The glass transition temperature of the obtained amorphous polyester resin 2 is 63° C., the weight average molecular weight is 24,000, and the acid value is 11 mgKOH/g. In addition, the SP value is 9.57.

Preparation of Amorphous Polyester Resin Dispersion 2

An amorphous polyester resin dispersion 2 is prepared in the same manner as in the preparation of the amorphous polyester resin dispersion 1 except that an amorphous polyester resin to be used is changed to Amo-2.

Synthesis of Amorphous Polyester Resin 3 (Amo-3)

An amorphous polyester resin 3 is obtained in the same manner as in the synthesis of the amorphous polyester resin 1 except that the following monomer components are used.
Bisphenol A ethylene oxide adduct: 210 parts
Bisphenol A propylene oxide adduct: 230 parts
Terephthalic acid: 30 parts
Fumaric acid: 135 parts

The glass transition temperature of the obtained amorphous polyester resin 3 is 62° C., the weight average molecular weight is 21,000, and the acid value is 13 mgKOH/g. In addition, the SP value is 9.72.

Preparation of Amorphous Polyester Resin Dispersion 3

An amorphous polyester resin dispersion 3 is prepared in the same manner as in the preparation of the amorphous polyester resin dispersion 1 except that an amorphous polyester resin to be used is changed to Amo-3.

Synthesis of Amorphous Polyester Resin 4 (Amo-4)

An amorphous polyester resin 4 is obtained in the same manner as in the synthesis of the amorphous polyester resin 1 except that the following monomer components are used.
Bisphenol A propylene oxide adduct: 350 parts
Terephthalic acid: 35 parts
Fumaric acid: 90 parts
Tetrapropenyl succinic anhydride: 13 parts

The glass transition temperature of the obtained amorphous polyester resin 4 is 58° C., the weight average molecular weight is 22,000, and the acid value is 12 mgKOH/g. In addition, the SP value is 9.70.

Preparation of Amorphous Polyester Resin Dispersion 4

An amorphous polyester resin dispersion 4 is prepared in the same manner as in the preparation of the amorphous polyester resin dispersion 1 except that an amorphous polyester resin to be used is changed to Amo-4.

Synthesis of Amorphous Polyester Resin 5 (Amo-5)

An amorphous polyester resin 5 is obtained in the same manner as in the synthesis of the amorphous polyester resin 1 except that the following monomer components are used.
Bisphenol A propylene oxide adduct: 350 parts
Terephthalic acid: 155 parts
Fumaric acid: 6 parts
Tetrapropenyl succinic anhydride: 13 parts

The glass transition temperature of the obtained amorphous polyester resin 5 is 60° C., the weight average molecular weight is 17,000, and the acid value is 16 mgKOH/g. In addition, the SP value is 9.89.

Preparation of Amorphous Polyester Resin Dispersion 5

An amorphous polyester resin dispersion 5 is prepared in the same manner as in the preparation of the amorphous polyester resin dispersion 1 except that an amorphous polyester resin to be used is changed to Amo-5.

Synthesis of Amorphous Polyester Resin 6 (Amo-6)

An amorphous polyester resin 6 is obtained in the same manner as in the synthesis of the amorphous polyester resin 1 except that the following monomer components are used.
Bisphenol A ethylene oxide adduct: 240 parts
Bisphenol A propylene oxide adduct: 260 parts
Terephthalic acid: 150 parts
Trimellitic acid: 15 parts
Tetrapropenyl succinic anhydride: 120 parts

The glass transition temperature of the obtained amorphous polyester resin 6 is 59° C., the weight average molecular weight is 28,000, and the acid value is 10 mgKOH/g. In addition, the SP value is 9.55.

Preparation of Amorphous Polyester Resin Dispersion 6

An amorphous polyester resin dispersion 6 is prepared in the same manner as in the preparation of the amorphous polyester resin dispersion 1 except that an amorphous polyester resin to be used is changed to Amo-6.

Synthesis of Crystalline Polyester Resin 1 (Cry-1)
1,10-Decane dicarboxylic acid: 350 parts
1,6-Hexanediol: 170 parts

The above-described monomer components are put into a reaction vessel provided with a stirrer, a thermometer, a condenser and a nitrogen gas introducing tube. The reaction vessel is purged with dry nitrogen gas and then 0.3 parts of tin octanoate with respect to 100 parts of the monomer components is added. The mixture is allowed to react under stirring for 3 hours at 160° C. in a nitrogen gas stream. The temperature is further increased to 180° C. over 1.5 hours and the pressure inside the reaction vessel is reduced to 3 kPa. The reaction ends when a desired molecular weight is obtained. Thus, a crystalline polyester resin 1 is obtained. The melting temperature of the obtained crystalline polyester resin 1 is 73° C., the weight average molecular weight is 28,000, and the acid value is 7.5 mgKOH/g. In addition, the SP value is 9.3.

Preparation of Crystalline Polyester Resin Dispersion 1
Cry-1: 100 parts
Methyl ethyl ketone: 60 parts
Isopropyl alcohol: 15 parts

The above-described components are put into a reaction vessel provided with a stirrer and dissolved at 65° C. After checking the dissolution, the temperature of the reaction vessel is cooled to 60° C. and then 5 parts of a 10% ammonia aqueous solution is added. Next, 300 parts of ion exchange water is added dropwise to the reaction vessel over 3 hours to prepare a polyester resin dispersion. Next, methyl ethyl ketone and isopropyl alcohol are removed by an evaporator to obtain a crystalline polyester resin dispersion 1.

Synthesis of Crystalline Polyester Resin 2 (Cry-2)

A crystalline polyester resin 2 is obtained in the same manner as in the synthesis of the crystalline polyester resin 1 except that the following monomer components are used.
1,10-Decane dicarboxylic acid: 350 parts
1,9-Nonanediol: 240 parts

The melting temperature of the obtained crystalline polyester resin 2 is 78° C., the weight average molecular weight is 33,000, and the acid value is 6.2 mgKOH/g. In addition, the SP value is 9.25.

Preparation of Crystalline Polyester Resin Dispersion 2

A crystalline polyester resin dispersion 2 is prepared in the same manner as in the preparation of the crystalline polyester resin dispersion 1 except that a crystalline polyester resin to be used is changed to Cry-2.

Synthesis of Crystalline Polyester Resin 3 (Cry-3)

A crystalline polyester resin 3 is obtained in the same manner as in the synthesis of the crystalline polyester resin 1 except that the following monomer components are used.
Adipic acid: 220 parts
1,10-Decanediol: 260 parts

The melting temperature of the obtained crystalline polyester resin 3 is 76° C., the weight average molecular weight is 28,000, and the acid value is 11.2 mgKOH/g. In addition, the SP value is 9.4.

Preparation of Crystalline Polyester Resin Dispersion 3

A crystalline polyester resin dispersion 3 is prepared in the same manner as in the preparation of the crystalline polyester resin dispersion 1 except that a crystalline polyester resin to be used is changed to Cry-3.

Synthesis of Crystalline Polyester Resin 4 (Cry-4)

A crystalline polyester resin 4 is obtained in the same manner as in the synthesis of the crystalline polyester resin 1 except that the following monomer components are used.
1,10-Decane dicarboxylic acid: 350 parts
1,4-Butanediol: 130 parts

The melting temperature of the obtained crystalline polyester resin 4 is 68° C., the weight average molecular weight is 24,000, and the acid value is 9.6 mgKOH/g. In addition, the SP value is 9.4.

Preparation of Crystalline Polyester Resin Dispersion 4

A crystalline polyester resin dispersion 4 is prepared in the same manner as in the preparation of the crystalline polyester resin dispersion 1 except that a crystalline polyester resin to be used is changed to Cry-4.

Synthesis of Crystalline Polyester Resin 5 (Cry-5)

A crystalline polyester resin 5 is obtained in the same manner as in the synthesis of the crystalline polyester resin 1 except that the following monomer components are used.
Sebacic acid: 300 parts
1,6-Hexanediol: 170 parts

The melting temperature of the obtained crystalline polyester resin 5 is 72° C., the weight average molecular weight is 26,000, and the acid value is 8.6 mgKOH/g. In addition, the SP value is 9.4.

Preparation of Crystalline Polyester Resin Dispersion 5

A crystalline polyester resin dispersion 5 is prepared in the same manner as in the preparation of the crystalline polyester resin dispersion 1 except that a crystalline polyester resin to be used is changed to Cry-5.

Synthesis of Crystalline Polyester Resin 6 (Cry-6)

A crystalline polyester resin 6 is obtained in the same manner as in the synthesis of the crystalline polyester resin 1 except that the following monomer components are used.
1,10-Decane dicarboxylic acid: 300 parts
Ethylene glycol: 100 parts

The melting temperature of the obtained crystalline polyester resin 6 is 77° C., the weight average molecular weight is 31,000, and the acid value is 6.1 mgKOH/g. In addition, the SP value is 9.5.

Preparation of Crystalline Polyester Resin Dispersion 6

A crystalline polyester resin dispersion 6 is prepared in the same manner as in the preparation of the crystalline polyester resin dispersion 1 except that a crystalline polyester resin to be used is changed to Cry-6.

Preparation of Styrene-Acryl Copolymer Resin Dispersion
Styrene: 126 parts
n-Butyl acrylate: 14 parts
Dodecanethiol: 2.1 parts
Isopropyl alcohol: 0.88 parts
Anionic surfactant (Dowfax, manufactured by Dow Chemical Inc.): 4 parts
Ion exchange water: 59.2 parts

The above-described components are put into a vessel to prepare an emulsion (monomer emulsion A) using a homogenizer.
Ion exchange water: 133 parts
Anionic surfactant (Dowfax, manufactured by Dow Chemical Inc.): 0.6 parts

On the other hand, the above-described components are put into a polymerization reaction vessel, slowly stirred while nitrogen is introduced after providing a reflux tube, the polymerization flask is heated to 75° C. over water bath. Then, the temperature is maintained.

In the vessel, 10 parts of the above-described monomer emulsion A is added dropwise using a metering pump over 10 minutes.

Next, 1.05 parts of ammonium persulfate is dissolved in 10 parts of ion exchange water and the solution is added dropwise into the polymerization flask using a metering pump over 10 minutes. In this state, the resultant is stirred for 1 hour. Further, the remaining monomer emulsion A is added dropwise to the polymerization flask using a metering pump over 2 hours.

When all the components are added, the resultant is further stirred for 3 hours to obtain a styrene-acryl copolymer resin dispersion.

Preparation of Release agent Dispersion
Hydrocarbon wax (trade name: FNP0090, manufactured by Nippon Seiro Co., Ltd., melting temperature Tw=90.2° C.): 270 parts
Anionic surfactant (Tayca Power BN2060, manufactured by Tayca Corporation, amount of active ingredients: 60%): 13.5 parts (3.0% with respect to the release agent as the active component)
Ion exchange water: 700 parts

The above-described components are mixed and a release agent is dissolved therein with a pressure ejecting type homogenizer (GAULIN homogenizer, manufactured by Manton Gaulin) at an internal liquid temperature of 120° C., subjected to a dispersion treatment at a dispersion pressure of 5 MPa for 120 minutes and then at 40 MPa for 360 minutes, and cooled to obtain a release agent dispersion. The volume average particle diameter D50v of the particles in the release agent dispersion is 220 nm. Thereafter, ion exchange water is added to adjust the solid content concentration to 20.0%.

Preparation of Black Colorant (Black) Dispersion
Carbon black (REGAL 330, manufactured by Cabot Corporation): 200 parts
Anionic surfactant (Neogen SC, manufactured by Dai-ichi Kogyo Seiyaku Co., Ltd.): 33 parts
   (active components: 60%, 10% with respect to the colorant)
Ion exchange water: 750 parts

The components as described above are put into a stainless steel container, which has a capacity such that the height of the liquid level is about ⅓ of the height of the container when all the components as described above are put into, and 280 parts of ion exchange water and an anionic surfactant are put and the surfactant is thoroughly dissolved therein. Then, all the pigments as described above are put thereinto, the mixture is sufficiently stirred until no dry pigments remain using a stirrer, the remaining ion exchange water is added thereto, and the mixture is further stirred for sufficient defoaming.

After defoaming, the mixture is dispersed at 5,000 rpm for 10 minutes using a homogenizer (ULTRA TURRAX T50, manufactured by IKA), and then stirred with a stirrer for a whole day and night for defoaming. After defoaming, the mixture is again dispersed using a homogenizer at 6,000 rpm for 10 minutes, and then stirred with a stirrer for a whole day and night for defoaming.

After defoaming, the mixture is dispersed with a high pressure impact type disperser ULTIMIZER (HJP30006, manufactured by Sugino Machine Limited) at a pressure of 240 MPa. Dispersion is performed for equivalently 25 passes in terms of the total injection amount and the processing capacity of the device.

The obtained dispersion is kept for 72 hours and the precipitates are removed. Ion exchange water is added thereto to adjust the solid content concentration to 15% thereby obtaining a black colorant dispersion. The volume average particle diameter D50v of the particles in the colorant dispersion is 110 nm.

Preparation of Cyan Colorant (Cyan) Dispersion
Cyan pigment (C.I. Pigment Blue 15:3 (copper phthalocyanine), manufactured by Dainichiseika Color & Chemicals Mfg. Co., Ltd.): 45 parts
Anionic surfactant (Neogen R, manufactured by Dai-ichi Kogyo Seiyaku Co., Ltd.): 2 parts
Ion exchange water: 250 parts

The above components are mixed, dissolved, and dispersed with a high pressure impact type disperser ULTIMIZER (HJP30006, manufactured by Sugino Machine Limited) for about 1 hour to obtain a cyan colorant dispersion. The volume average particle diameter D50v of the particles in the colorant dispersion is 150 nm.

Preparation of Magenta Colorant (Magenta) Dispersion
Magenta pigment (Pigment Red 122 (quinacridone pigment), manufactured by Dainichiseika Color & Chemicals Mfg. Co., Ltd.): 45 parts
Anionic surfactant (Neogen R, manufactured by Dai-ichi Kogyo Seiyaku Co., Ltd.): 5 parts
Ion exchange water: 200 parts

The above components are mixed, dissolved, and dispersed with a homogenizer (ULTRA TURRAX T50, manufactured by IKA) for 10 minutes to obtain a magenta colorant dispersion. The volume average particle diameter D50v of the particles in the colorant dispersion is 160 nm.

Preparation of Yellow Colorant (Yellow) Dispersion
Yellow pigment (Hansa Yellow 2GX70, manufactured by Clariant): 45 parts
Anionic surfactant (Dowfax, manufactured by Dow Chemical Inc.): 5 parts
Ion exchange water: 180 parts

The above-described components are mixed, dissolved, and dispersed with a homogenizer (ULTRA TURRAX T50, manufactured by IKA) for 10 minutes to obtain a yellow colorant dispersion. The volume average particle diameter D50v of the particles in the colorant dispersion is 130 nm.

### Example 1

### Preparation of Toner Particles 1

Amo-1: 52.8 parts
Cry-1: 16.1 parts
Colorant: 6 parts
Release agent: 1.5 parts

Each dispersion is weighed so that the components have above weights as toner core components. Each dispersion is put into a round stainless flask and ion exchange water is added to adjust the solid content concentration to 12.5%. Further, 6.3 parts of a 10% aqueous aluminum sulfate solution is added. Next, the components are mixed and dispersed with a homogenizer (ULTRA TURRAX T50, manufactured by IKA) for 10 minutes at 5000 rpm and are heated to 40° C. under stirring while stirring the contents in the flask. Subsequently, the temperature is increased by 0.5° C. per minute. The temperature is maintained when the particle size is 4.5 μm.
Amo-1: 20.5 parts
Release agent: 3 parts

Next, each dispersion is weighed so that components have above weight as toner shell components and mixed, and the mixed dispersion is put into the flask and retained for 60 minutes. When the obtained contents are observed with an optical microscope, it is confirmed that aggregated particles are formed. 11 parts of tetrasodium salt of ethylenediaminetetraacetic acid (EDTA) (CHELEST 40, manufactured by CHELEST CORPORATION) is added and then an aqueous sodium hydroxide solution is added to adjust the pH to 8. Thereafter, the temperature is increased to 82.5° C. and then, the pH is lowered by 0.05 using nitric acid every 10 minutes, while stirring is continued for 45 minutes. After cooling, the resultant is filtrated, sufficiently washed with ion exchange water, and dried to obtain Toner Particles 1.

Preparation of Toner 1

1.5 parts of hydrophobic silica (RY50, manufactured by Nippon Aerosil Co., Ltd.) is added to 100 parts of the obtained Toner Particles 1 and mixed using a sample mill at 13000 rpm for 30 seconds. Then, the mixture is sieved with a vibration screen having a mesh of 45 μm to prepare Toner 1.

The physical properties of the obtained Toner 1 are collectively shown in Tables 1 and 2.

Evaluation 1: Evaluation of Thermal Storage Properties

2 g of the obtained toner is stored under conditions of a temperature of 55° C. and a humidity of 50 RH % for 12 hours. The toner is evaluated based on the following evaluation criteria by visually observing the state of the toner after being stored.
A: Toner aggregates are rarely observed and thermal storage properties are excellent even after being stored at 55° C.
B: A small amount of toner aggregates are observed and thermal storage properties are slightly deteriorated after being stored at 55° C. compared to A.
C: Toner aggregates are observed and thermal storage properties are deteriorated after being stored at 55° C. compared to A.
D: Toner is aggregated and does not have thermal storage properties after being stored at 55° C.

There are no practical problems in toners with grades A to C. The results are shown in Table 2.

Preparation of Resin Coated Carrier
Mn—Mg—Sr ferrite particle (average particle size: 40 μm): 100 parts
Toluene: 14 parts
Cyclohexyl methacrylate/dimethylaminoethyl methacrylate copolymer (weight ratio: 99:1, Mw: 80,000) 2.0 parts
Carbon Black (VXC 72, manufactured by Cabot Corporation): 0.12 parts

The above-described components excluding ferrite particles and glass beads (φ 1 mm, the same amount as that of toluene) are stirred using a sand mill (manufactured by KANSAI PAINT CO., LTD.) at 1200 rpm for 30 minutes to obtain a resin coating layer forming solution. Further, the resin coating layer forming solution and the ferrite particles are put into a vacuum deaeration type kneader and the pressure is reduced to distill off toluene for drying. Thus, a resin coated carrier (C) is obtained.

Preparation of Developer

36 parts of the obtained Toner 1 and 414 parts of the carrier are put into a 2-liter V-blender, stirred for 20 minutes, and then sieved using a mesh of 212 μm, thereby manufacturing a developer 1.

Evaluation 2: Evaluation of Low Temperature Fixability

A DOCUCENTRE COLOR 400 CP (manufactured by Fuji Xerox Co., Ltd.) as an image forming apparatus according to an exemplary embodiment is prepared and an electromagnetic induction type fixing device mounted on the apparatus is modified so as to control a fixing temperature. In addition, the fixing device is modified so that the device is driven by an externally attached drive motor.

Separately, using a DOCUCENTRE COLOR 400 CP (manufactured by Fuji Xerox Co., Ltd.) as an image forming apparatus, and paper J (manufactured by Fuji Xerox Co., Ltd.) as a recording medium, an image is formed so that the toner applied amount is adjusted to 13.5 g/m² and thus an unfixed solid image (25 mm×25 mm) is prepared.

Using a modified machine of DOCUCENTRE COLOR 400 CP, the fixing temperature is increased from 100° C. to 200° C. in increments of 10° C. and the unfixed solid image (25 mm×25 mm) is fixed at a transport rate of 175 mm/sec for each temperature.

An image surface of the fixed image at each temperature is bent and the degree of peeling of the image in the folded portion is observed. The width of the paper appearing in the folded portion as a result of peeling of the image is measured. The fixing temperature at which the width is 0.5 mm or less is set to a minimum fixing temperature (MFT, ° C.).

The evaluation criteria are as follows. The results are shown in Table 2.
A: MFT is 120° C. or lower and low temperature fixability is exhibited.
B: MFT is 135° C. or lower and low temperature fixability is slightly deteriorated compared to A.
C: MFT is 150° C. or lower and low temperature fixability is poorer than A.
D: MFT is 150° C. or higher and the toner does not have low temperature fixability.

There are no practical problems in toners with grades A to C.

### Example 2

Toner Particles 2 are prepared in the same manner as in the preparation of Toner Particles 1 except that the following components are used as toner core components and as toner shell components.

Toner Core Components
Amo-1: 45.8 parts
Cry-2: 15.9 parts
St/Ac particle: 5 parts
Colorant: 11 parts
Release agent: 1.5 parts

Toner Shell Components
Amo-1: 17.8 parts
Release agent: 3 parts

The obtained Toner Particles 2 are used to obtain Toner 2 and Developer 2 in the same manner as in Example 1. Evaluation is performed in the same manner as in Example 1 except that Toner 2 and Developer 2 are used. The obtained results and the properties of Toner 2 are collectively shown in Tables 1 and 2.

### Example 3

Toner Particles 3 are prepared in the same manner as in the preparation of Toner Particles 1 except that the following components are used as toner core components and as toner shell components.

Toner Core Components
Amo-2: 21.1 parts
Amo-6: 21.1 parts
Cry-1: 19.5 parts
St/Ac particle: 10 parts
Colorant: 7.5 parts
Release agent: 1.5 parts

Toner Shell Components
Amo-2: 8.2 parts
Amo-6: 8.2 parts
Release agent: 3 parts

The obtained Toner Particles 3 are used to obtain Toner 3 and Developer 3 in the same manner as in Example 1. Evaluation is performed in the same manner as in Example 1 except that Toner 3 and Developer 3 are used. The obtained results and the properties of Toner 3 are collectively shown in Tables 1 and 2.

### Example 4

Toner Particles 4 are prepared in the same manner as in the preparation of Toner Particles 1 except that the following components are used as toner core components and as toner shell components.

Toner Core Components
Amo-3: 22.1 parts
Amo-1: 22.1 parts
Cry-1: 9.2 parts
St/Ac particle: 15 parts
Colorant: 10 parts
Release agent: 1.5 parts

Toner Shell Components
Amo-3: 8.6 parts
Amo-1: 8.6 parts
Release agent: 3 parts

The obtained Toner Particles 4 are used to obtain Toner 4 and Developer 4 in the same manner as in Example 1. Evaluation is performed in the same manner as in Example 1 except that Toner 4 and Developer 4 are used. The obtained results and the properties of Toner 4 are collectively shown in Tables 1 and 2.

### Example 5

Toner Particles 5 are prepared in the same manner as in the preparation of Toner Particles 1 except that the following components are used as toner core components and as toner shell components.

Toner Core Components
Amo-4: 27.6 parts
Amo-1: 17.6 parts
Cry-3: 17.7 parts
St/Ac particle: 5 parts
Colorant: 10 parts
Release agent: 1.5 parts

Toner Shell Components
Amo-4: 8.8 parts
Amo-1: 8.8 parts
Release agent: 3 parts

The obtained Toner Particles 5 are used to obtain Toner 5 and Developer 5 in the same manner as in Example 1. Evaluation is performed in the same manner as in Example 1 except that Toner 5 and Developer 5 are used. The obtained results and the properties of Toner 5 are collectively shown in Tables 1 and 2.

### Example 6

Toner Particles 6 are prepared in the same manner as in the preparation of Toner Particles 1 except that the following components are used as toner core components and as toner shell components.

Toner Core Components
Amo-1: 24.8 parts
Amo-5: 18.8 parts
Cry-4: 19.1 parts
St/Ac particle: 10 parts
Colorant: 6 parts
Release agent: 1.5 parts

Toner Shell Components
Amo-1: 8.5 parts
Amo-5: 8.5 parts
Release agent: 3 parts

The obtained Toner Particles 6 are used to obtain Toner 6 and Developer 6 in the same manner as in Example 1. Evaluation is performed in the same manner as in Example 1 except that Toner 6 and Developer 6 are used. The obtained results and the properties of Toner 6 are collectively shown in Tables 1 and 2.

### Example 7

Toner Particles 7 are prepared in the same manner as in the preparation of Toner Particles 1 except that the following components are used as toner core components and as toner shell components.

Toner Core Components
Amo-1: 23.5 parts
Amo-2: 23.5 parts
Cry-2: 14.3 parts
St/Ac particle: 5 parts
Colorant: 11 parts
Release agent: 1.5 parts

Toner Shell Components
Amo-1: 9.1 parts
Amo-2: 9.1 parts
Release agent: 3 parts

The obtained Toner Particles 7 are used to obtain Toner 7 and Developer 7 in the same manner as in Example 1. Evaluation is performed in the same manner as in Example 1 except that Toner 7 and Developer 7 are used. The obtained results and the properties of Toner 7 are collectively shown in Tables 1 and 2.

### Example 8

Toner Particles 8 are prepared in the same manner as in the preparation of Toner Particles 1 except that the following components are used as toner core components and as toner shell components.

Toner Core Components
Amo-1: 22.9 parts
Amo-2: 22.9 parts
Cry-1: 15.9 parts
St/Ac particle: 10 parts
Colorant: 6 parts
Release agent: 1.5 parts

Toner Shell Components
Amo-1: 8.9 parts
Amo-2: 8.9 parts
Release agent: 3 parts

The obtained Toner Particles 8 are used to obtain Toner 8 and Developer 8 in the same manner as in Example 1. Evaluation is performed in the same manner as in Example 1 except that Toner 8 and Developer 8 are used. The obtained results and the properties of Toner 8 are collectively shown in Tables 1 and 2.

### Example 9

Toner Particles 9 are prepared in the same manner as in the preparation of Toner Particles 1 except that the following components are used as toner core components and as toner shell components.

Toner Core Components
Amo-6: 19.5 parts
Amo-2: 19.5 parts
Cry-1: 15.3 parts
St/Ac particle: 15 parts
Colorant: 11 parts
Release agent: 1.5 parts

Toner Shell Components
Amo-6: 7.6 parts
Amo-2: 7.6 parts
Release agent: 3 parts

The obtained Toner Particles 9 are used to obtain Toner 9 and Developer 9 in the same manner as in Example 1. Evaluation is performed in the same manner as in Example 1 except that Toner 9 and Developer 9 are used. The obtained results and the properties of Toner 9 are collectively shown in Tables 1 and 2.

### Example 10

Toner Particles 10 are prepared in the same manner as in the preparation of Toner Particles 1 except that the following components are used as toner core components and as toner shell components.

Toner Core Components
Amo-6: 20.1 parts
Amo-2: 20.1 parts
Cry-4: 19.6 parts
St/Ac particle: 10 parts
Colorant: 10 parts
Release agent: 1.5 parts

Toner Shell Components
Amo-6: 7.8 parts
Amo-2: 7.8 parts
Release agent: 3 parts

The obtained Toner Particles 10 are used to obtain Toner 10 and Developer 10 in the same manner as in Example 1. Evaluation is performed in the same manner as in Example 1 except that Toner 10 and Developer 10 are used. The obtained results and the properties of Toner 10 are collectively shown in Tables 1 and 2.

### Example 11

Toner Particles 11 are prepared in the same manner as in the preparation of Toner Particles 1 except that the following components are used as toner core components and as toner shell components.

Toner Core Components
Amo-1: 23.0 parts
Amo-3: 23.0 parts
Cry-1: 14.0 parts
St/Ac particle: 10 parts
Colorant: 7.5 parts
Release agent: 1.5 parts

Toner Shell Components
Amo-1: 9.0 parts
Amo-3: 9.0 parts
Release agent: 3 parts

The obtained Toner Particles 11 are used to obtain Toner 11 and Developer 11 in the same manner as in Example 1. Evaluation is performed in the same manner as in Example 1 except that Toner 11 and Developer 11 are used. The obtained results and the properties of Toner 11 are collectively shown in Tables 1 and 2.

### Example 12

Toner Particles 12 are prepared in the same manner as in the preparation of Toner Particles 1 except that the following components are used as toner core components and as toner shell components.

Toner Core Components
Amo-1: 20.4 parts
Amo-2: 20.4 parts
Cry-1: 17.9 parts
St/Ac particle: 10 parts
Colorant: 11 parts
Release agent: 1.5 parts

Toner Shell Components
Amo-1: 7.9 parts
Amo-2: 7.9 parts
Release agent: 3 parts

The obtained Toner Particles 12 are used to obtain Toner 12 and Developer 12 in the same manner as in Example 1. Evaluation is performed in the same manner as in Example 1 except that Toner 12 and Developer 12 are used. The obtained results and the properties of Toner 12 are collectively shown in Tables 1 and 2.

### Example 13

Toner Particles 13 are prepared in the same manner as in the preparation of Toner Particles 1 except that the following components are used as toner core components and as toner shell components.

Toner Core Components
Amo-1: 21.5 parts
Amo-5: 21.5 parts
Cry-4: 14.9 parts
St/Ac particle: 15 parts
Colorant: 6 parts
Release agent: 1.5 parts

Toner Shell Components
Amo-1: 8.3 parts
Amo-5: 8.3 parts
Release agent: 3 parts

The obtained Toner Particles 13 are used to obtain Toner 13 and Developer 13 in the same manner as in Example 1. Evaluation is performed in the same manner as in Example 1 except that Toner 13 and Developer 13 are used. The obtained results and the properties of Toner 13 are collectively shown in Tables 1 and 2.

### Example 14

Toner Particles 14 are prepared in the same manner as in the preparation of Toner Particles 1 except that the following components are used as toner core components and as toner shell components.

Toner Core Components
Amo-2: 44.6 parts
Cry-1: 13.6 parts
St/Ac particle: 10 parts
Colorant: 10 parts
Release agent: 1.5 parts

Toner Shell Components
Amo-2: 17.4 parts
Release agent: 3 parts

The obtained Toner Particles 14 are used to obtain Toner 14 and Developer 14 in the same manner as in Example 1. Evaluation is performed in the same manner as in Example 1 except that Toner 14 and Developer 14 are used. The obtained results and the properties of Toner 14 are collectively shown in Tables 1 and 2.

### Example 15

Toner Particles 15 are prepared in the same manner as in the preparation of Toner Particles 1 except that the following components are used as toner core components and as toner shell components.

Toner Core Components
Amo-1: 22.3 parts
Amo-4: 22.3 parts
Cry-1: 17.5 parts
St/Ac particle: 5 parts
Colorant: 11 parts
Release agent: 1.5 parts

Toner Shell Components
Amo-1: 8.7 parts
Amo-4: 8.7 parts
Release agent: 3 parts

The obtained Toner Particles 15 are used to obtain Toner 15 and Developer 15 in the same manner as in Example 1. Evaluation is performed in the same manner as in Example 1 except that Toner 15 and Developer 15 are used. The obtained results and the properties of Toner 15 are collectively shown in Tables 1 and 2.

### Example 16

Toner Particles 16 are prepared in the same manner as in the preparation of Toner Particles 1 except that the following components are used as toner core components and as toner shell components.

Toner Core Components
Amo-1: 22.5 parts
Amo-3: 22.5 parts
Cry-4: 15.6 parts
St/Ac particle: 10 parts
Colorant: 7.5 parts
Release agent: 1.5 parts

Toner Shell Components
Amo-1: 8.7 parts
Amo-3: 8.7 parts
Release agent: 3 parts

The obtained Toner Particles 16 are used to obtain Toner 16 and Developer 16 in the same manner as in Example 1. Evaluation is performed in the same manner as in Example 1 except that Toner 16 and Developer 16 are used. The obtained results and the properties of Toner 16 are collectively shown in Tables 1 and 2.

### Example 17

Toner Particles 17 are prepared in the same manner as in the preparation of Toner Particles 1 except that the following components are used as toner core components and as toner shell components.

Toner Core Components
Amo-1: 23.1 parts
Amo-4: 23.1 parts
Cry-1: 20.3 parts
St/Ac particle: 5 parts
Colorant: 6 parts
Release agent: 1.5 parts

Toner Shell Components
Amo-1: 9.0 parts
Amo-4: 9.0 parts
Release agent: 3 parts

The obtained Toner Particles 17 are used to obtain Toner 17 and Developer 17 in the same manner as in Example 1. Evaluation is performed in the same manner as in Example 1 except that Toner 17 and Developer 17 are used. The obtained results and the properties of Toner 17 are collectively shown in Tables 1 and 2.

### Example 18

Toner Particles 18 are prepared in the same manner as in the preparation of Toner Particles 1 except that the following components are used as toner core components and as toner shell components.

Toner Core Components
Amo-1: 22.2 parts
Amo-4: 22.2 parts
Cry-4: 26.4 parts
St/Ac particle: 0 parts
Colorant: 7.5 parts
Release agent: 1.5 parts

Toner Shell Components
Amo-1: 8.6 parts
Amo-4: 8.6 parts
Release agent: 3 parts

The obtained Toner Particles 18 are used to obtain Toner 18 and Developer 18 in the same manner as in Example 1. Evaluation is performed in the same manner as in Example 1 except that Toner 18 and Developer 18 are used. The obtained results and the properties of Toner 18 are collectively shown in Tables 1 and 2.

### Example 19

Toner Particles 19 are prepared in the same manner as in the preparation of Toner Particles 1 except that the following components are used as toner core components and as toner shell components.

Toner Core Components
Amo-1: 20.5 parts
Amo-5: 16.5 parts
Cry-4: 34.2 parts
St/Ac particle: 0 parts
Colorant: 10 parts
Release agent: 1.5 parts

Toner Shell Components
Amo-1: 7.2 parts
Amo-5: 7.2 parts
Release agent: 3 parts

THE obtained Toner Particles 19 are used to obtain Toner 19 and Developer 19 in the same manner as in Example 1. Evaluation is performed in the same manner as in Example 1 except that Toner 19 and Developer 19 are used. The obtained results and the properties of Toner 19 are collectively shown in Tables 1 and 2.

### Comparative Example 1

Toner Particles 20 are prepared in the same manner as in the preparation of Toner Particles 1 except that the following components are used as toner core components and as toner shell components.

Toner Core Components
Amo-1: 24.1 parts
Amo-3: 24.1 parts
Cry-1: 7.5 parts
St/Ac particle: 10 parts
Colorant: 11 parts
Release agent: 1.5 parts

Toner Shell Components
Amo-1: 9.4 parts
Amo-3: 9.4 parts
Release agent: 3 parts

The obtained Toner Particles 20 are used to obtain Toner 20 and Developer 20 in the same manner as in Example 1. Evaluation is performed in the same manner as in Example 1 except that Toner 20 and Developer 20 are used. The obtained results and the properties of Toner 20 are collectively shown in Tables 1 and 2.

### Comparative Example 2

Toner Particles 21 are prepared in the same manner as in the preparation of Toner Particles 1 except that the following components are used as toner core components and as toner shell components.

Toner Core Components
Amo-1: 23.9 parts
Amo-3: 23.9 parts
Cry-5: 16.6 parts
St/Ac particle: 5 parts
Colorant: 7.5 parts
Release agent: 1.5 parts

Toner Shell Components
Amo-1: 9.3 parts
Amo-3: 9.3 parts
Release agent: 3 parts

The obtained Toner Particles 21 are used to obtain Toner 21 and Developer 21 in the same manner as in Example 1. Evaluation is performed in the same manner as in Example 1 except that Toner 21 and Developer 21 are used. The obtained results and the properties of Toner 21 are collectively shown in Tables 1 and 2.

### Comparative Example 3

Toner Particles 22 are prepared in the same manner as in the preparation of Toner Particles 1 except that the following components are used as toner core components and as toner shell components.

Toner Core Components
Amo-1: 25.5 parts
Amo-5: 25.5 parts
Cry-1: 8.7 parts
St/Ac particle: 10 parts
Colorant: 6 parts
Release agent: 1.5 parts

Toner Shell Components
Amo-1: 9.9 parts
Amo-5: 9.9 parts
Release agent: 3 parts

The obtained Toner Particles 22 are used to obtain Toner 22 and Developer 22 in the same manner as in Example 1. Evaluation is performed in the same manner as in Example 1 except that Toner 22 and Developer 22 are used. The obtained results and the properties of Toner 22 are collectively shown in Tables 1 and 2.

### Comparative Example 4

Toner Particles 23 are prepared in the same manner as in the preparation of Toner Particles 1 except that the following components are used as toner core components and as toner shell components.

Toner Core Components
Amo-6: 22.3 parts
Amo-2: 22.3 parts
Cry-4: 13.6 parts
St/Ac particle: 10 parts
Colorant: 10 parts
Release agent: 1.5 parts

Toner Shell Components
Amo-6: 8.7 parts
Amo-2: 8.7 parts
Release agent: 3 parts

The obtained Toner Particles 23 are used to obtain Toner 23 and Developer 23 in the same manner as in Example 1. Evaluation is performed in the same manner as in Example 1 except that Toner 23 and Developer 23 are used. The obtained results and the properties of Toner 23 are collectively shown in Tables 1 and 2.

### Comparative Example 5

Toner Particles 24 are prepared in the same manner as in the preparation of Toner Particles 1 except that the following components are used as toner core components and as toner shell components.

Toner Core Components
Amo-1: 21.5 parts
Amo-2: 21.5 parts
Cry-6: 14.9 parts
St/Ac particle: 10 parts
Colorant: 11 parts
Release agent: 1.5 parts

Toner Shell Components
Amo-1: 8.3 parts
Amo-2: 8.3 parts
Release agent: 3 parts

The obtained Toner Particles 24 are used to obtain Toner 24 and Developer 24 in the same manner as in Example 1. Evaluation is performed in the same manner as in Example 1 except that Toner 24 and Developer 24 are used. The obtained results and the properties of Toner 24 are collectively shown in Tables 1 and 2.

TABLE 1

| | | | | | St/Ac | | Temperature when | G′ (after thermal |
|---|---|---|---|---|---|---|---|---|
| | Kind of | | | | ratio | Cry ratio | G′ = 1.0 × 10⁸ Pa | storage) |
| | pigment | Amo1 | Amo2 | Cry | (%) | (%) | (° C.) | (Pa) |
| Example 1 | Cyan | Amo-1 | — | Cry-1 | 0 | 18 | 43 | 1.5 × 10⁸ |
| Example 2 | Magenta | Amo-1 | — | Cry-2 | 6 | 20 | 45 | 4.8 × 10⁸ |
| Example 3 | Black | Amo-2 | Amo-6 | Cry-1 | 11 | 25 | 35 | 2.8 × 10⁸ |
| Example 4 | Yellow | Amo-3 | Amo-1 | Cry-1 | 18 | 13 | 44 | 1.6 × 10⁸ |
| Example 5 | Yellow | Amo-4 | Amo-1 | Cry-3 | 6 | 22 | 36 | 2.4 × 10⁸ |
| Example 6 | Cyan | Amo-5 | Amo-1 | Cry-4 | 11 | 24 | 43 | 2.2 × 10⁸ |
| Example 7 | Magenta | Amo-2 | Amo-1 | Cry-2 | 6 | 18 | 43 | 2.6 × 10⁸ |
| Example 8 | Cyan | Amo-2 | Amo-1 | Cry-1 | 11 | 20 | 37 | 2.5 × 10⁸ |
| Example 9 | Magenta | Amo-2 | Amo-6 | Cry-1 | 18 | 22 | 43 | 4.1 × 10⁸ |
| Example 10 | Yellow | Amo-2 | Amo-6 | Cry-4 | 12 | 26 | 33 | 1.8 × 10⁸ |
| Example 11 | Black | Amo-3 | Amo-1 | Cry-1 | 11 | 18 | 42 | 1.4 × 10⁸ |
| Example 12 | Magenta | Amo-2 | Amo-1 | Cry-1 | 12 | 24 | 33 | 2.5 × 10⁸ |
| Example 13 | Cyan | Amo-5 | Amo-1 | Cry-4 | 17 | 20 | 42 | 3.2 × 10⁸ |
| Example 14 | Yellow | Amo-2 | — | Cry-1 | 12 | 18 | 42 | 1.3 × 10⁸ |
| Example 15 | Magenta | Amo-4 | Amo-1 | Cry-1 | 6 | 22 | 36 | 2.6 × 10⁸ |
| Example 16 | Black | Amo-3 | Amo-1 | Cry-4 | 11 | 20 | 36 | 1.4 × 10⁸ |
| Example 17 | Cyan | Amo-4 | Amo-1 | Cry-1 | 6 | 24 | 35 | 2.1 × 10⁸ |
| Example 18 | Black | Amo-4 | Amo-1 | Cry-4 | 0 | 30 | 32 | 1.3 × 10⁸ |
| Example 19 | Yellow | Amo-5 | Amo-1 | Cry-4 | 0 | 40 | 31 | 1.1 × 10⁸ |
| Comparative | Magenta | Amo-3 | Amo-1 | Cry-1 | 12 | 10 | 55 | 3.0 × 10⁸ |
| Example 1 | | | | | | | | |
| Comparative | Black | Amo-3 | Amo-1 | Cry-5 | 6 | 20 | 40 | 5.0 × 10⁷ |
| Example 2 | | | | | | | | |
| Comparative | Cyan | Amo-5 | Amo-1 | Cry-1 | 11 | 11 | 47 | 1.5 × 10⁸ |
| Example 3 | | | | | | | | |
| Comparative | Yellow | Amo-2 | Amo-6 | Cry-4 | 12 | 18 | 38 | 6.8 × 10⁷ |
| Example 4 | | | | | | | | |
| Comparative | Magenta | Amo-2 | Amo-1 | Cry-6 | 12 | 20 | 48 | 2.4 × 10⁸ |
| Example 5 | | | | | | | | |

TABLE 2

| | | | Thermal | | | | |
|---|---|---|---|---|---|---|---|
| | Low | Thermal | storage | Amo/Cry SP | Cry melting | | |
| | temperature | storage | temperature | value | temperature | | Amo Sp value |
| | fixability | properties | (° C.) | difference | (° C.) | Kind of Amo | difference |
| Example 1 | B | B | 53 | 0.17 | 73 | 1 | — |
| Example 2 | B | A | 55 | 0.22 | 78 | 1 | — |
| Example 3 | A | A | 55 | 0.26 | 73 | 2 | 0.02 |
| Example 4 | B | B | 50 | 0.30 | 73 | 2 | 0.25 |
| Example 5 | A | A | 55 | 0.20 | 76 | 2 | 0.23 |
| Example 6 | B | A | 53 | 0.26 | 68 | 2 | 0.42 |
| Example 7 | B | A | 55 | 0.27 | 78 | 2 | 0.10 |
| Example 8 | A | A | 55 | 0.22 | 73 | 2 | 0.10 |
| Example 9 | B | A | 53 | 0.26 | 73 | 2 | 0.02 |
| Example 10 | A | B | 53 | 0.16 | 68 | 2 | 0.02 |
| Example 11 | B | B | 53 | 0.30 | 73 | 2 | 0.25 |
| Example 12 | A | A | 55 | 0.22 | 73 | 2 | 0.10 |
| Example 13 | B | A | 55 | 0.28 | 68 | 2 | 0.42 |
| Example 14 | B | B | 50 | 0.27 | 73 | 1 | — |
| Example 15 | A | A | 55 | 0.29 | 73 | 2 | 0.23 |
| Example 16 | A | B | 53 | 0.20 | 68 | 2 | 0.25 |
| Example 17 | A | A | 55 | 0.29 | 73 | 2 | 0.23 |
| Example 18 | A | B | 55 | 0.19 | 68 | 2 | 0.23 |
| Example 19 | A | B | 50 | 0.26 | 68 | 2 | 0.42 |
| Comparative | D | A | 55 | 0.30 | 73 | 2 | 0.25 |
| Example 1 | | | | | | | |
| Comparative | A | D | 50 | 0.20 | 72 | 2 | 0.25 |
| Example 2 | | | | | | | |
| Comparative | D | B | 53 | 0.38 | 73 | 2 | 0.42 |
| Example 3 | | | | | | | |
| Comparative | A | D | 50 | 0.16 | 68 | 2 | 0.02 |
| Example 4 | | | | | | | |
| Comparative | D | A | 55 | 0.02 | 77 | 2 | 0.10 |
| Example 5 | | | | | | | |

In Tables 1 and 2, the term “St/Ac ratio” means a ratio of styrene-acryl copolymer resin to the bonder resin, the term “Cry ratio” means a ratio of crystalline polyester resin to the total of amorphous polyester resin and crystalline polyester resin, and the term “temperature when G′=1.0×10⁸ Pa” means a temperature at which the storage elastic modulus G′ is 1.0×10⁸ Pa. The term “G′ (after thermal storage)” means a storage elastic modulus G′ (after thermal storage) at X′° C., the term “thermal storage temperature” means a value of X′° C., and the term “Amo/Cry SP value difference” means the absolute value of the difference between the SP value of amorphous polyester resin and the SP value of crystalline polyester resin. The term of “Amo SP value difference” means the absolute value of the difference between the SP values of two kinds of amorphous polyester resins.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
a binder resin containing an amorphous polyester resin and a crystalline polyester resin,
wherein a ratio of the crystalline polyester resin to a total of the amorphous polyester resin and the crystalline polyester resin is from 12% by weight to 40% by weight, and
the toner satisfies the following equations (1) and (2),
30° C.≦T1≦45° C. (1)
1.0×10⁸ Pa≦G′(X)≦5.0×10⁸ Pa (2)
wherein T1 represents a temperature at which a storage elastic modulus G′ is 1.0×10⁸ Pa; G′(X) represents a storage elastic modulus G′(B) at a temperature X′° C. (after thermal storage); and X′° C. represents a temperature at which a ratio of a storage elastic modulus G′(B) at the temperature X° C. after the toner is stored at the temperature X° C. for 2 hours (after thermal storage) to a storage elastic modulus G′(A) at a temperature X° C. before the toner is stored at the temperature X° C. (before thermal storage), [storage elastic modulus G′(B) (after thermal storage)/storage elastic modulus G′(A) (before thermal storage)], has a maximum value.

2. The electrostatic charge image developing toner according to claim 1,
wherein an absolute value of a difference between an SP value of the amorphous polyester resin and an SP value of the crystalline polyester resin is from 0.15 to 0.30.

3. The electrostatic charge image developing toner according to claim 1,
wherein the ratio of the crystalline polyester resin to the total of the amorphous polyester resin and the crystalline polyester resin is from 14% by weight to 30% by weight.

4. The electrostatic charge image developing toner according to claim 1,
wherein the T1 is within a range of 30° C. to 40° C.

5. The electrostatic charge image developing toner according to claim 1,
wherein the storage elastic modulus G′(X) is within a range of 1.0×10⁸ Pa to 4.0×10⁸ Pa.

6. The electrostatic charge image developing toner according to claim 1,
wherein an absolute value of a difference between an SP value of the amorphous polyester resin and an SP value of the crystalline polyester resin is from 0.20 to 0.30.

7. An electrostatic charge image developer comprising:
the electrostatic charge image developing toner according to claim 1; and
an electrostatic charge image developing carrier.

8. A toner cartridge comprising:
a container that accommodates the electrostatic charge image developing toner according to claim 1,
and is detachable from an image forming apparatus.

9. A process cartridge comprising:
a developing unit that accommodates the electrostatic charge image developer according to claim 7 and develops an electrostatic charge image formed on a surface of an image holding member with the electrostatic charge image developer to form a toner image,
wherein the process cartridge is detachable from an image forming apparatus.

10. An image forming apparatus comprising:
an image holding member;
a charging unit that charges a surface of the image holding member;
an electrostatic charge image forming unit that forms an electrostatic charge image on a charged surface of the image holding member;
a developing unit that contains the electrostatic charge image developer according to claim 7 and develops the electrostatic charge image formed on the surface of the image holding member with the electrostatic charge image developer to form a toner image;
a transfer unit that transfers the toner image formed on the surface of the image holding member onto a surface of a recording medium; and
a fixing unit that fixes the toner image transferred onto the surface of the recording medium.
